(19) United States
(12) Patent Application Publication
(10) Pub. No.: US 2017/0057123 A1
(43) Pub. Date: Mar. 2, 2017

(54) MOLD MANUFACTURING METHOD, ROLL-SHAPED MOLD MANUFACTURING APPARATUS, AND METHOD FOR MANUFACTURING ARTICLE WITH MICRORELIEF STRUCTURE ON SURFACE

(71) Applicant: Mitsubishi Rayon Co., LTD., Tokyo (JP)

(72) Inventors: Shohei SAKAI, Otake-shi (JP); Yuji MATSUBARA, Otake-shi (JP)

(21) Appl. No.: 15/301,879

(22) PCT Filed: Apr. 1, 2015
(86) PCT No.: PCT/JP2015/060339

§ 371 Date: Nov. 3, 2016

(30) Foreign Application Priority Data
Apr. 8, 2014 (JP) 2014-079414

(51) Int. Cl. B29C 33/62; B29C 59/02; B29C 33/38; B29C 59/04

(52) U.S. Cl. CPC B29C 33/62; B29C 59/04; B29C 59/022; B29C 33/3842; B29C 2059/023; B29K 2105/0002

(57) ABSTRACT

Provided is a method for manufacturing a roll-shaped mold wherein a mold release agent layer is formed on a mold body. A mold release agent solution is supplied from a mold release agent-discharging nozzle towards the mold body to adhere the mold release agent solution on the mold body. A gas is discharged from a gas-discharging nozzle toward the mold release agent solution adhering to the mold body to dry the mold release agent solution and form the mold release agent layer.

### TECHNICAL FIELD

The present invention relates to a method of manufacturing a mold in which a mold release agent layer is formed on a main mold body, an apparatus for manufacturing a roll-shaped mold, and a method for manufacturing an article with a microrelief structure on a surface.

This application claims the benefit of Japanese Patent Application No. 2014-079414, filed in Japan on Apr. 8, 2014, which is hereby incorporated by reference as if fully set forth herein.

### BACKGROUND ART

An article with a microrelief structure, in which an average interval of protrusions or depressions is less than or equal to a wavelength of visible light, on a surface is known to exhibit a reflection preventing effect, Lotus effect, etc. In particular, a nano-order microrelief structure referred to as a moth-eye structure is known to serve as an effective means for preventing reflection when a refractive index continuously increases from a refractive index of air to a refractive index of a material of an article.

For example, a method of transferring a microrelief structure of a roll-shaped mold to a surface of an article using the roll-shaped mold, which has a reversal structure of the microrelief structure formed on an outer circumferential surface, (nanoimprint method) is known as a method of forming the microrelief structure on the surface of the article.

For example, the roll-shaped mold is manufactured by a method including a process of manufacturing a roll-shaped main mold body having a microrelief structure on an outer circumferential surface, and a process of forming a mold release agent layer on the outer circumferential surface of the main mold body.

For example, methods below have been proposed as a method of forming the mold release agent layer on the outer circumferential surface of the main mold body.

(1) A method of immersing the roll-shaped main mold body in a mold release agent solution, and taking the main mold body out of the mold release agent solution (Patent Document 1).

(2) A method of directly applying a mold release agent solution to the outer circumferential surface of the roll-shaped main mold body while rotating the main mold body using a central axis as a rotation axis, and drying the mold release agent solution applied to the outer circumferential surface of the main mold body using a heater (Patent Document 2).

In the method (1), the main mold body needs to be taken out at an ultra-low speed so as not to ruffle a surface of a mold release agent process liquid when the main mold body is taken out of the mold release agent process liquid. For this reason, it takes a long time to take the main mold body out of the mold release agent process liquid. In particular, when the main mold body increases in size, it takes a considerably long time to take the main mold body out of the mold release agent process liquid, and the roll-shaped mold cannot be efficiently manufactured.

In the method (2), since the mold release agent solution is directly applied to the outer circumferential surface of the main mold body, stripe-shaped application unevenness is likely to be generated. In addition, since the mold release agent solution applied to the outer circumferential surface of the main mold body is dried using the heater, stripe-shaped application unevenness, a drip, etc. remain on a mold release agent layer without change, and a film thickness of the mold release agent layer is uneven. When the film thickness of the mold release agent layer is uneven, at the time of transferring the microrelief structure of the roll-shaped mold to the surface of the article, a shape is uneven in the microrelief structure on the surface of the article. Thus, an article having an excellent appearance or performance cannot be obtained.

### CITATION LIST

### Patent Document

Patent Document 1: WO 2012/176794 A

Patent Document 2: JP 2006-331585 A

### SUMMARY OF THE INVENTION

### Problem to be Solved by the Invention

The invention provides a method of manufacturing a mold capable of efficiently manufacturing a mold in which unevenness of a film thickness of a mold release agent layer is suppressed, an apparatus for manufacturing a roll-shaped mold, and a method for manufacturing an article with a microrelief structure on a surface.

### Means for Solving Problem

Examples of the invention may include a method of manufacturing a mold of [1] to [11] below, an apparatus for manufacturing a roll-shaped mold of [12] to [16] below, and a method for manufacturing an article with a microrelief structure on a surface of [17] to [20] below.

[1] A method of manufacturing a mold in which a mold release agent layer is formed on a main mold body, the method including supplying a mold release agent solution toward an outer circumferential surface of the main mold body from a mold release agent discharging means disposed to be separated from the main mold body to attach the mold release agent solution to the main mold body, and discharging gas toward the mold release agent solution attached to the main mold body from a gas discharging means disposed to be separated from the main mold body to dry the mold release agent solution, thereby forming the mold release agent layer.

[2] The method according to [1], wherein the main mold body is a roll-shaped main mold body having an external shape corresponding to a cylindrical shape, and the mold release agent solution is supplied to an outer circumferential surface of the roll-shaped main mold body while the roll-shaped main mold body is rotated using a central axis of the roll-shaped main mold body as a rotation axis.

[3] The method according to [2], wherein the roll-shaped main mold body is held and rotated such that the central axis is in a horizontal direction.

[4] The method according to [2] or [3], wherein the mold release agent solution is supplied toward the outer circumferential surface of the main mold body from the mold release agent discharging means while the main mold body and the mold release agent discharging means are relatively moved from a first end portion to a second end portion of the main mold body in parallel with the central axis of the main mold body.

[5] The method according to [4], wherein gas is discharged toward the mold release agent solution attached to the outer circumferential surface of the main mold body from the gas discharging means while the main mold body and the gas discharging means are relatively moved such that the gas discharging means disposed at a rear of the mold release agent discharging means in a movement direction of the mold release agent discharging means follows the mold release agent discharging means.

[6] The method according to any one of [3] to [5], wherein the mold release agent solution is attached to the outer circumferential surface of the main mold body by discharging the mold release agent solution toward a lower half on the outer circumferential surface of the main mold body from the mold release agent discharging means.

[7] The method according to any one of [2] to [6], wherein the mold release agent solution is supplied toward the outer circumferential surface of the main mold body from a plurality of mold release agent discharging means arranged side by side at equal intervals along a longitudinal direction of the main mold body.

[8] The method according to [7], wherein gas is discharged toward the mold release agent solution attached to the outer circumferential surface of the main mold body from the gas discharging means while the mold release agent solution is successively attached to the outer circumferential surface of the main mold body by supplying the mold release agent solution toward the outer circumferential surface of the main mold body in order from the mold release agent discharging means on a side of the first end portion of the main mold body among the plurality of mold release agent discharging means arranged side by side at equal intervals along the longitudinal direction of the main mold body.

[9] The method according to any one of [2] to [8], wherein gas is discharged toward the mold release agent solution attached to the outer circumferential surface of the main mold body from the gas discharging means such that a discharge direction of the gas from the gas discharging means is a direction opposite to a rotation direction of the main mold body.

[10] The method according to any one of [2] to [9], wherein gas is discharged toward the mold release agent solution attached to the outer circumferential surface of the main mold body and positioned in an upper half on the outer circumferential surface of the main mold body from the gas discharging means positioned higher than the mold release agent discharging means.

[11] The method according to any one of [1] to [15], wherein the main mold body corresponds to a structure having a plurality of minute protrusions and depressions, in which an average interval of respective adjacent protrusions or depressions is set to 400 nm or less, on the outer circumferential surface of the main mold body.

[12] An apparatus for manufacturing a roll-shaped mold in which a mold release agent layer is formed on an outer circumferential surface of a roll-shaped main mold body, the apparatus including a rotating means for rotating the main mold body using a central axis of the main mold body as a rotation axis, a mold release agent discharging means disposed to be separated from the main mold body to discharge a mold release agent solution toward the outer circumferential surface of the main mold body, thereby attaching the mold release agent solution to the outer circumferential surface of the main mold body, and a gas discharging means disposed to be separated from the main mold body to discharge gas toward the mold release agent solution attached to the outer circumferential surface of the main mold body, thereby drying the mold release agent solution to form the mold release agent layer.

[13] The apparatus according to [12], wherein the rotating means holds the roll-shaped main mold body such that the central axis is in a horizontal direction, and rotates the roll-shaped main mold body.

[14] The apparatus according to [12] or [13], wherein the mold release agent discharging means is relatively movable with respect to the main mold body in parallel with the central axis of the main mold body.

[15] The apparatus according to [14], wherein the gas discharging means is disposed at a rear of the mold release agent discharging means in a movement direction of the mold release agent discharging means, and is relatively movable with respect to the main mold body by following the mold release agent discharging means.

[16] The apparatus according to any one of [17] to [23], wherein the main mold body corresponds to a structure having a plurality of minute protrusions and depressions, in which an average interval of respective adjacent protrusions or depressions is set to 400 nm or less, on the outer circumferential surface of the main mold body.

[17] A method for manufacturing an article with a microrelief structure on a surface, the method including forming a structuring having a plurality of protrusions and depressions, an average period of which is 400 nm or less, on a surface of a roll-shaped main mold body, attaching a mold release agent solution to an outer circumferential surface of the main mold body by supplying the mold release agent solution toward the outer circumferential surface of the main mold body from a mold release agent discharging means disposed to be separated from the main mold body while rotating the main mold body using a central axis of the main mold body as a rotation axis, and manufacturing an article with a plurality of protrusions, in which an average interval of adjacent protrusions is 400 nm or less, on a surface by transferring a structure of the surface of the main mold body on which a mold release agent layer is formed to a curable resin layer using a mold manufactured by discharging gas toward the mold release agent solution attached to the outer circumferential surface of the main mold body from a gas discharging means disposed to be separated from the main mold body to dry the mold release agent solution to form the mold release agent layer.

[18] The method according to [17], wherein the roll-shaped main mold body is held and rotated such that the central axis is in a horizontal direction.

[19] The method according to [18], wherein the roll-shaped main mold body is obtained by supplying the mold release agent solution to the outer circumferential surface of the main mold body from the mold release agent discharging means while relatively moving the main mold body and the mold release agent discharging means from a first end portion to a second end portion of the main mold body in parallel with the central axis of the main mold body.

[20] The method according to [19], wherein the roll-shaped main mold body is obtained by discharging gas to the mold release agent solution attached to the outer circumferential surface of the main mold body from the gas discharging means while relatively moving the main mold body and the gas discharging means such that the gas discharging means disposed at a rear of the mold release agent discharging means in a movement direction of the mold release agent discharging means follows the mold release agent discharging means.

Referring to the “upper half on the outer circumferential surface of the main mold body” or the “lower half on the outer circumferential surface of the main mold body” described in the invention, when the roll-shaped main mold body is divided into halves by a straight line in a diametrical direction passing through the central axis, a side facing roughly upward in a vertical direction is set as the “upper half on the outer circumferential surface”, and a side facing roughly downward is set as the “lower half on the outer circumferential surface”.

### Effect of the Invention

According to a method of manufacturing a mold of the invention, it is possible to efficiently manufacture a mold in which unevenness of a film thickness of a mold release agent layer is suppressed.

According to an apparatus for manufacturing a roll-shaped mold of the invention, it is possible to efficiently manufacture a roll-shaped mold in which unevenness of a film thickness of a mold release agent layer is suppressed.

According to a method for manufacturing an article with a microrelief structure on a surface of the invention, it is possible to efficiently manufacture an article in which accuracy of a microrelief shape is improved.

### BRIEF DESCRIPTION OF DRAWINGS

FIG. 1 is a cross-sectional view illustrating an example of a process of manufacturing a main mold body having a microrelief structure on a surface;

FIG. 2 is a top view illustrating an apparatus for manufacturing a roll-shaped mold used in a first embodiment of the invention;

FIG. 3 is a front view illustrating the manufacturing apparatus of FIG. 2 when viewed in a horizontal direction;

FIG. 4 is a side view of a portion of the manufacturing apparatus of FIG. 2 when viewed in a central axis direction of the main mold body;

FIG. 5 is a top view illustrating a state in which a mold release agent discharging nozzle and a gas discharging nozzle are moved in the manufacturing apparatus of FIG. 2;

FIG. 6 is a top view illustrating an apparatus for manufacturing a roll-shaped mold used in a second embodiment of the invention;

FIG. 7 is a front view illustrating the manufacturing apparatus of FIG. 6 when viewed in a horizontal direction;

FIG. 8 is a side view of a portion of the manufacturing apparatus of FIG. 6 when viewed in a central axis direction of a main mold body; and

FIG. 9 is a perspective view illustrating an example of a manufacturing apparatus used when an article with a microrelief structure on a surface is manufactured.

### MODE(S) FOR CARRYING OUT THE INVENTION

Definitions of terms below are applied throughout the present specification and claims.

A “relief structure” refers to a structure having a plurality of protrusions and/or a plurality of depressions.

A “microrelief structure” refers to a structure which has a plurality of protrusions and/or a plurality of depressions, an average interval of which corresponds to nano-order.

“Nano-order” refers to greater than or equal to 1 nm and less than 1 μm.

“Gas” is presumed to contain every gas such as air and inert gas useful to dry a mold surface.

A “pore” refers to a depression having a microrelief structure formed on an oxide film on a surface of an aluminum base material.

A “pore interval” refers to a distance between centers of adjacent pores.

An “outer circumferential surface of a main mold body” refers to an outermost circumferential surface having a shape (a relief structure, a mirror surface, etc.) transferred to an article. Therefore, when a small-diameter portion, a diameter of which is smaller than a body portion having an outermost circumferential surface, is present at both ends of the main mold body, an outer circumferential surface of the small-diameter portion cannot be contained in the “outer circumferential surface of the main mold body”.

An “end portion of the main mold body” refers to an end portion of the body portion having the outermost circumferential surface in a longitudinal direction of the main mold body. Therefore, when the small-diameter portion, the diameter of which is smaller than the body portion having the outermost circumferential surface, is present at the both ends of the main mold body, the small-diameter portion cannot be contained in the “end portion of the main mold body”.

A “roll shape” refers to a columnar structure such as a cylindrical shape and a hollow cylindrical shape having a continuous outer circumferential surface.

A “spread width w of a mold release agent solution” refers to a width at which a mold release agent solution spreads on the outer circumferential surface of the main mold body during one revolution of the main mold body when the mold release agent solution is discharged toward the outer circumferential surface of the main mold body from a mold release agent discharging nozzle and attached to the outer circumferential surface of the main mold body (see FIG. 2, etc.).

An “initial retention time” refers to a time from when a mold release agent solution starts to be discharged from the mold release agent discharging nozzle toward an outer circumferential surface of a first end portion of the main mold body and a portion around the outer circumferential surface until the mold release agent solution attached to the outer circumferential surface of the first end portion of the main mold body starts to be dried by discharging gas from a gas discharging nozzle.

A “wetted time” refers to a time from when the mold release agent solution is attached to the outer circumferential surface of the main mold body until the mold release agent solution starts to be dried.

<Mold (Roll-Shaped Mold)>

In the present embodiment, a description will be given using a roll-shaped mold as an example of a mold. This roll-shaped mold is used to form a shape corresponding to a shape of an outer circumferential surface of the roll-shaped mold on a surface of an article by transferring the shape (a relief structure, a mirror surface, etc.) of the outer circumferential surface of the roll-shaped mold to the surface of the article.

Examples of the roll-shaped mold include a roll-shaped mold, which is used for a nanoimprint method, having a microrelief structure on a surface, an embossing roll used for an embossing formation, a roll-shaped stamper used to form a bit of a recording medium, etc.

The roll-shaped mold, which is obtained using a manufacturing method of the present embodiment, includes a roll-shaped main mold body and a mold release agent layer formed on an outer circumferential surface of the main mold body.

(Main Mold Body)

The main mold body of the present embodiment is obtained by forming a relief structure on an outer circumferential surface of a roll-shaped base material, or by finishing the outer circumferential surface of the roll-shaped base material as a mirror surface.

The main mold body may have a hollow shape or a solid shape.

The relief structure may be formed in at least a portion of the outer circumferential surface of the main mold body, and may or may not be formed on the whole outer circumferential surface of the main mold body.

Examples of the base material include metal (including metal on which an oxide film is formed), quartz, glass, resin, ceramics, etc., and metal is preferable in that a minute relief structure is easily formed on a surface.

A main mold body obtained by forming a microrelief structure on an outer circumferential surface of a roll-shaped base material is preferable as the main mold body in that an effect of the invention is sufficiently exhibited.

Hereinafter, a detailed description will be given of a method of manufacturing the main mold body having the microrelief structure on the outer circumferential surface.

(Method of Manufacturing Main Mold Body)

Examples of a method of manufacturing the main mold body include method (I-1), method (I-2), etc. described below, and method (I-1) is preferably in that an area can be enlarged and manufacturing is easy.

(I-1) Method of forming anodized alumina having a plurality of pores (a porous oxide film of aluminum) on an outer circumferential surface of a roll-shaped aluminum base material

(I-2) Method of directly forming a microrelief structure on an outer circumferential surface of a roll-shaped base material using an electron beam lithography method, a laser beam interference method, etc.

A method having processes (a) to (f) below is preferable as method (I-1).

(a) Process of anodizing a roll-shaped aluminum base material in an electrolyte at a constant voltage to form an oxide film on an outer circumferential surface of the aluminum base material

(b) Process of removing a portion or all of the oxide film, and forming a pore originating point of anodic oxidation on the outer circumferential surface of the aluminum base material

(c) Process of re-anodizing the aluminum base material in the electrolyte after process (b), and forming an oxide film having a pore at the pore originating point

(d) Process of enlarging a diameter of the pore after process (c)

(e) Process of performing anodic oxidation again in the electrolyte after process (d)

(f) Process of repeating process (d) and process (e) to obtain a main mold body in which anodized alumina having a plurality of pores is formed on the outer circumferential surface of the aluminum base material

Process (a):

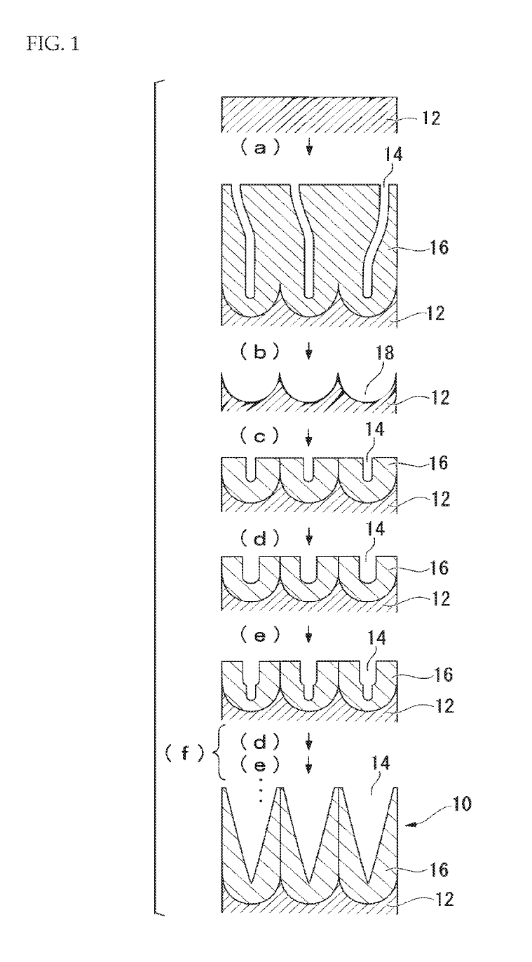

As illustrated in FIG. 1, an oxide film 16 having a pore 14 is formed by anodizing an aluminum base material 12 (see (a) of FIG. 1).

For example, it is preferable to polish the aluminum base material using mechanical polishing, fabric polishing, chemical polishing, electrolytic polishing treatment (etching treatment), etc. in order to smooth a surface state. In addition, it is preferable to degrease the aluminum base material in advance before anodic oxidation since oil, which is used when the aluminum base material is processed in a predetermined shape, may be attached to the aluminum base material.

Purity of aluminum is preferably 99% or more, more preferably 99.5% or more, and even more preferably 99.8% or more. When purity of aluminum is low, a relief structure having a size at which visible light is scattered due to segregation of impurities may be formed at the time of anodic oxidation, or regularity of pores obtained by anodic oxidation may be degraded.

Examples of the electrolyte include an aqueous solution of oxalic acid, sulfuric acid, etc. One type of electrolyte may be separately used, and two or more types of electrolytes may be used in combination.

When an oxalic acid aqueous solution is used as the electrolyte:

A concentration of oxalic acid is preferably 0.7 M or less. When the concentration of oxalic acid exceeds 0.7 M, a current value may become excessively high, and a surface of the oxide film may become rough.

When the oxalic acid aqueous solution is used as the electrolyte, it is possible to obtain anodized alumina including pores having high regularity corresponding to an average interval of 10 nm when a formation voltage is in a range of 30 to 60 V. Regularity is prone to decrease when the formation voltage is higher or lower than the range.

A temperature of the electrolyte is preferably 60° C. or less, and more preferably 45° C. or less. When the temperature of the electrolyte exceeds 60° C., a phenomenon referred to as so-called “burning” occurs. Thus, the pores may be damaged, or a surface may be melted, and thus regularity of the pores may be disordered.

A sulfuric acid aqueous solution is used as the electrolyte:

A concentration of sulfuric acid is preferably 0.7 M or less. When the concentration of sulfuric acid exceeds 0.7 M, a current value may become excessively high, and thus a constant voltage may not be maintained.

When the sulfuric acid aqueous solution is used as the electrolyte, it is possible to obtain anodized alumina including pores having high regularity corresponding to an average interval of 63 nm when a formation voltage is in a range of 25 to 30 V. Regularity is prone to decrease when the formation voltage is higher or lower than the range.

A temperature of the electrolyte is preferably 30° C. or less, and more preferably 20° C. or less. When the temperature of the electrolyte exceeds 30° C., a phenomenon referred to as so-called “burning” occurs. Thus, the pores may be damaged, or a surface may be melted, and thus regularity of the pores may be disordered.

Process (b):

As illustrated in FIG. 1, regularity of pores may be improved by temporarily removing a portion or all of the oxide film 16 to form a pore originating point 18 of anodic oxidation (see (b) of FIG. 1). Even in a state in which the whole oxide film 16 is not removed, and a portion of the oxide film 16 is left, when a portion in which regularity is previously sufficiently increased is left in the oxide film 16, an object of removing the oxide film may be achieved.

Examples of a method of removing the oxide film 16 include a method of removing the oxide film 16 by dissolving the oxide film 16 in a solution for selectively dissolving the oxide film 16 without dissolving aluminum. Examples of this solution include a chromic acid/phosphoric acid mixed liquid, etc.

Process (c):

As illustrated in FIG. 1, an oxide film 16 having a columnar pore 14 is formed by re-anodizing the aluminum base material 12 from which the oxide film is removed (see (c) of FIG. 1).

Anodic oxidation in process (c) may be performed in a similar condition to that of process (a). As an anodic oxidation time is increased, a deeper pore may be obtained.

Process (d):

As illustrated in FIG. 1, a treatment for enlarging a diameter of the pore 14 (hereinafter referred to as a pore diameter enlargement treatment) is performed (see (d) of FIG. 1). The pore diameter enlargement treatment is a treatment for enlarging the diameter of the pore 14 obtained through anodic oxidation by immersion in a solution that dissolves the oxide film 16. Examples of this solution include a phosphoric acid aqueous solution of about 5% by mass, etc.

As a time for the pore diameter enlargement treatment is increased, the diameter of the pore increases.

Process (e):

As illustrated in FIG. 1, a columnar pore 16 having a small diameter and further extending downward from a bottom portion of the columnar pore 16 is formed by performing anodic oxidation again (see (d) of FIG. 1).

Anodic oxidation in process (e) may be performed in a similar condition to that of process (a). As an anodic oxidation time is increased, a deeper pore may be obtained.

Process (f):

As illustrated in FIG. 1, an oxide film 16 including a pore 14 having a shape in which a diameter continuously decreases from an opening portion in a depth direction is formed by repeating process (d) and process (e) (see (f) of FIG. 1). In this way, a main mold body 10 having anodized alumina (a porous oxide film of aluminum) on a surface of the aluminum base material 12 is obtained. It is preferable that process (d) be a final process.

Process (d) and process (e) described above are preferably repeated three times in total, and more preferably repeated five times or more. When process (d) and process (e) are repeated two times or less, the diameter of the pore discontinuously decreases. Thus, a reflectance reducing effect of a microrelief structure (moth-eye structure) formed by transferring a shape of anodized alumina having this pore is insufficient.

Examples of the shape of the pore 14 include a substantially conic shape, a pyramidal shape, a cylindrical shape, a bell shape, etc., and it is preferable to adopt a shape such as the conic shape or the pyramidal shape in which a cross-sectional area of the pore in a direction perpendicular to a depth direction continuously decreases from an outermost surface in the depth direction.

An average interval between pores 14 is preferably less than or equal to the wavelength of visible light, that is, less than or equal to 400 nm. The average interval between pores 14 is preferably larger than or equal to 20 nm.

The average interval between pores 14 described in the present embodiment is obtained by measuring an interval between adjacent pores 14 (a distance from a center of a pore 14 to a center of an adjacent pore 14) through electron microscope observation fifty times, and averaging values thereof.

A depth of the pore 14 is preferably nano-order, more preferably in a range of 80 to 500 nm, even more preferably in a range of 120 to 400 nm, and particularly preferably in a range of 150 nm to 300 nm.

The depth of the pore 14 described in the present embodiment is a value obtained by measuring a distance between a lowermost portion of the pore 14 and an uppermost portion of a protrusion present between pores 14 when observation is performed at a magnification of 30,000 through electron microscope observation.

An aspect ratio (depth of pore/average interval between pores) of the pore 14 is preferably in a range of 0.8 to 5.0, more preferably in a range of 1.2 to 4.0, and even more preferably in a range of 1.5 to 3.0.

The main mold body 10 obtained in this way is provided to a method of manufacturing a roll-shaped mold of the invention described below, and a roll-shaped mold in which a mold release agent layer is formed on an outer circumferential surface of a main mold body is obtained.

(Mold Release Agent Layer)

A mold release agent layer is a layer formed by attaching a mold release agent solution to an outer circumferential surface of a main mold body, and drying the mold release agent solution.

In the mold release agent layer, a mold release agent contained in the mold release agent solution may be present in the same state without chemical change, or the mold release agent contained in the mold release agent solution may be present in a chemically changed state.

Examples of the mold release agent include silicone resin, fluoride resin, a fluorine compound (details are described below), phosphate ester, etc., and the fluorine compound or phosphate ester is preferable in that a mold release characteristic can be maintained for a long time.

Examples of a commercial product of the fluorine compound include “Fluorolink” (registered trademark) manufactured by Solvay Specialty Polymers Japan Co., Ltd., fluoroalkylsilane “KBM-7803” (registered trademark) manufactured by Shin-Etsu Chemical Co., Ltd., “MRAF” (registered trademark) manufactured by Asahi glass Co., Ltd., “OPTOOL HD1100” (registered trademark) manufactured by HARVES Co., Ltd., “OPTOOL HD2100 series” (registered trademark), “OPTOOL DSX” (registered trademark) manufactured by DAIKIN INDUSTRIES LTD., “Novec EGC-1720” (registered trademark) manufactured by Sumitomo 3M Limited, “FS-2050” series manufactured by Fluoro Technology Co., Ltd., etc.

A (poly)oxyalkylene alkyl phosphate compound is preferable as phosphate ester in that the mold release characteristic can be maintained for a long time. Examples of a commercial product include “JP-506H” manufactured by Johoku Chemical Co., Ltd., “Moldwiz INT-1856” (registered trademark) manufactured by Axell Corporation, “TDP-10”, “TDP-8”, “TDP-6”, “TDP-2”, “DDP-10”, “DDP-8”, “DDP-6”, “DDP-4”, “DDP-2”, “TLP-4”, “TCP-5”, and “DLP-10” manufactured by Nikko Chemicals Co., Ltd., etc.

One type of mold release agent may be separately used, and two or more types of mold release agents may be used in combination.

<Method of manufacturing mold (method of manufacturing roll-shaped mold)>

A method of manufacturing a mold of the invention is a method of manufacturing a mold in which a mold release agent layer is formed on a main mold body, and is a method of supplying a mold release agent solution toward a main mold body from a mold release agent discharging means disposed to be separated from the main mold body to attach the mold release agent solution to the main mold body, and drying the mold release agent solution by discharging gas toward the mold release agent solution attached to the main mold body from a gas discharging means disposed to be separated from the main mold body to form a mold release agent layer. An example described in the present embodiment is a method including an attaching step (S1) below and a drying step (S2) below when a roll-shaped mold is manufactured.

(S1) Step of attaching a mold release agent solution to an outer circumferential surface of a main mold body by supplying the mold release agent solution toward the outer circumferential surface of the main mold body from a mold release agent discharging means disposed to be separated from the main mold body while rotating the main mold body using a central axis of the main mold body as a rotation axis

(S2) Step of forming a mold release agent layer by drying the mold release agent solution by discharging gas toward the mold release agent solution attached to the outer circumferential surface of the main mold body from a gas discharging means disposed to be separated from the main mold body while rotating the main mold body using the central axis of the main mold body as the rotation axis

In the invention, both the attaching step (S1) and the drying step (S2) may be simultaneously performed, the attaching step (S1) may be first performed, and then the drying step (S2) may be performed, or the attaching step (S1) and the drying step (S2) may be alternately performed. In addition, in the invention, for example, the main mold body may be rotated while holding the main mold body such that the central axis of the main mold body is in a direction other than a vertical direction.

However, when both the attaching step (S1) and the drying step (S2) are simultaneously performed, and when the attaching step (S1) and the drying step (S2) are alternately performed, it is preferable not to discharge a mold release agent solution toward a region in which drying is completed (the mold release agent layer) from the mold release agent discharging means, that is, not to apply the mold release agent solution twice in the attaching step (S1).

Hereinafter, a detailed description will be given of a method of manufacturing a mold of the invention while representing a specific embodiment. In the present embodiment, a description will be given using a case, in which the above-described roll-shaped mold is manufactured as the mold, as an example.

### First Embodiment

### Method of Manufacturing Roll-Shaped Mold

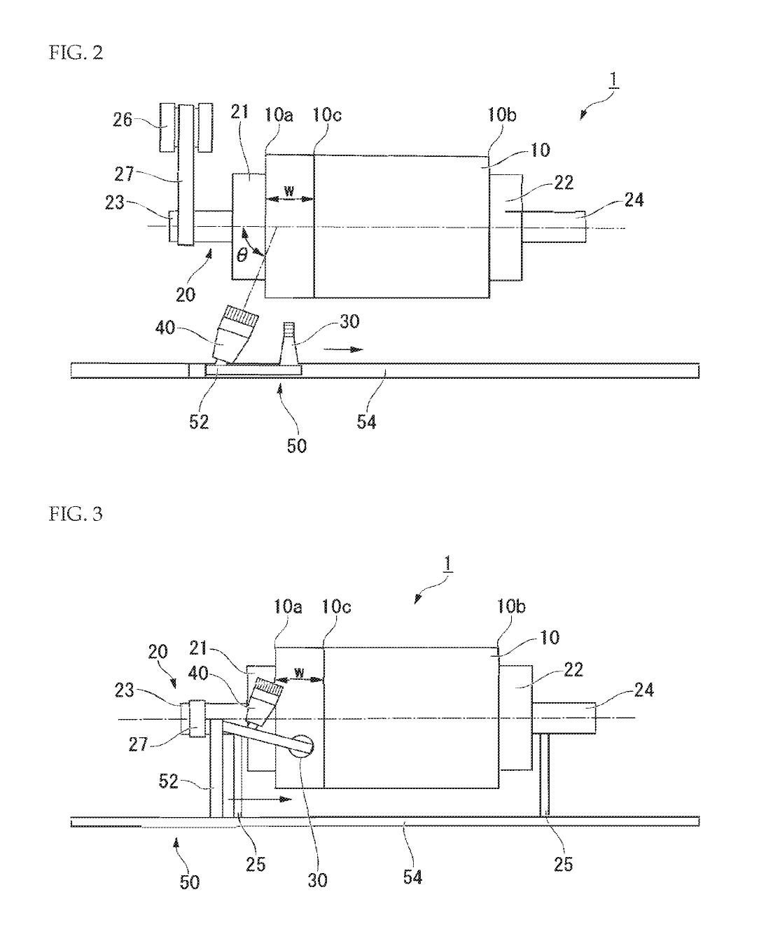

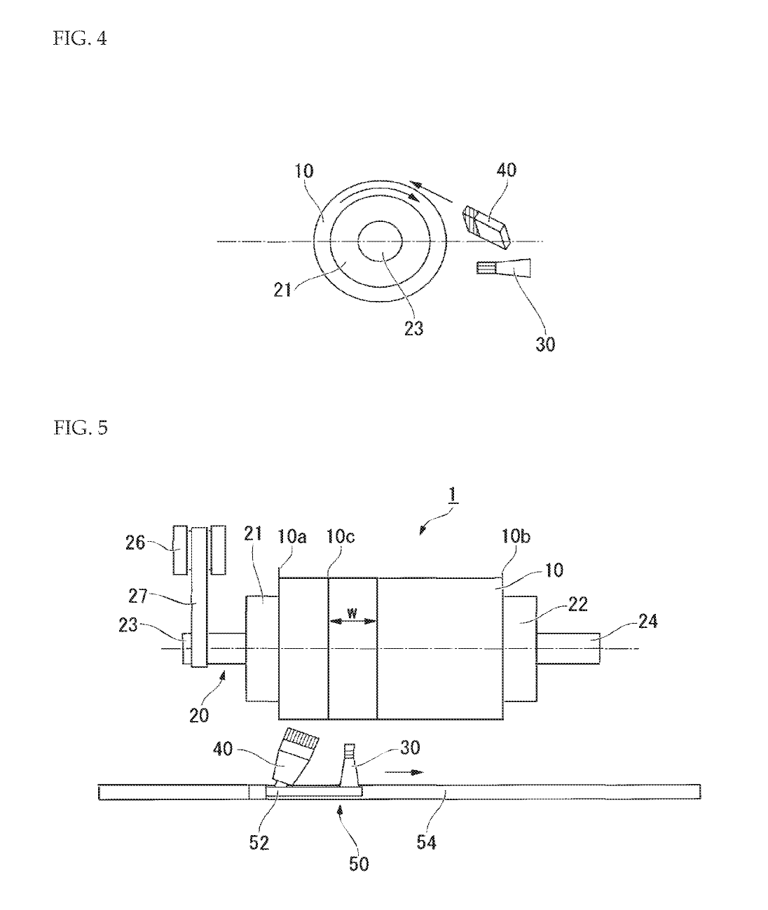

FIG. 2 is a top view illustrating an apparatus for manufacturing a roll-shaped mold used in a first embodiment of the invention, FIG. 3 is a front view illustrating the manufacturing apparatus of FIG. 2 when viewed in a horizontal direction, and FIG. 4 is a side view of a portion of the manufacturing apparatus of FIG. 2 when viewed in a central axis direction of a main mold body.

A manufacturing apparatus 1 includes a rotating mechanism (rotating means) for rotating a roll-shaped main mold body 10 using a central axis of the main mold body 10 as a rotation axis, a mold release agent discharging nozzle 30 (mold release agent discharging means) disposed to be separated from the main mold body 10 to discharge a mold release agent solution toward an outer circumferential surface of the main mold body 10, thereby attaching the mold release agent solution to the outer circumferential surface of the main mold body 10, a gas discharging nozzle 40 (gas discharging means) disposed to be separated from the main mold body 10 to discharge gas toward the mold release agent solution attached to the outer circumferential surface of the main mold body 10, thereby drying the mold release agent solution to form a mold release agent layer, and a moving mechanism (moving means) 50 for moving the mold release agent discharging nozzle 30 and the gas discharging nozzle 40 in parallel with the central axis of the main mold body 10. In addition, in the present embodiment, a description will be given using, as an example, an apparatus further including a control means (not illustrated) for not discharging the mold release agent solution toward a region in which drying is completed (the mold release agent layer) from the mold release agent discharging nozzle 30 by controlling the moving mechanism 50.

Rotating Mechanism:

The rotating mechanism 20 includes a main shaft-side holder 21 that holds the main mold body 10 on a side of a first end portion 10a, a tail-side holder 22 that holds the main mold body 10 on a side of a second end portion 10b, a main shaft-side shaft 23 connected to the main shaft-side holder 21 coaxially with the central axis of the main mold body 10, a tail-side shaft 24 connected to the tail-side holder 22 coaxially with the central axis of the main mold body 10, a shaft support 25 that supports the main shaft-side shaft 23 and the tail-side shaft 24, a rotation driving unit 26 including a motor (not illustrated), etc., and a belt 27 that transmits rotation of the rotation driving unit 26 to the main shaft-side shaft 23.

Even though the main mold body 10 is held such that the central axis of the main mold body 10 is in the horizontal direction in an illustrated example, the main mold body 10 may be held such that the central axis of the main mold body 10 is in a direction other than the vertical direction in the invention. When the main mold body 10 is held such that the central axis of the main mold body 10 is in the vertical direction, if drying is gradually performed from an upper part toward a lower part of the main mold body 10, a wetted time may be longer in the lower part than in the upper part of the main mold body 10. Thus, irregularity in film thickness of the mold release agent layer is easily generated in the upper part and the lower part of the main mold body 10. In addition, application unevenness due to dripping is easily generated. Therefore, when the main mold body 10 is held such that the central axis of the main mold body 10 is in the vertical direction, irregularity in film thickness of the mold release agent layer is easily generated in the first end portion 10a side and the second end portion 10b side of the main mold body 10. Further, it is preferable that the main mold body 10 be held such that the central axis of the main mold body 10 is within 10° with respect to the horizontal direction, and it is particularly preferable that the main mold body 10 be held such that the central axis of the main mold body 10 is in the horizontal direction.

In addition, a shaft member (not illustrated) such as a mandrel inserted into a hollow roll-shaped main mold body by penetrating an inside of the roll-shaped main mold body may be used in place of the main shaft-side holder 21 and the tail-side holder 22 in the illustrated example.

In addition, the rotating mechanism 20 may relatively rotate the mold release agent discharging nozzle 30, the gas discharging nozzle 40, and the main mold body 10. For example, the rotating mechanism 20 may be a mechanism that rotates the mold release agent discharging nozzle 30 and the gas discharging nozzle 40 around the main mold body 10.

Mold Release Agent Discharging Nozzle:

A shape of a discharge opening of the mold release agent discharging nozzle 30 is a circular shape.

The mold release agent discharging nozzle 30 is disposed such that a mold release agent solution discharged from the mold release agent discharging nozzle 30 is attached to a lower half on the outer circumferential surface of the main mold body 10.

In addition, the mold release agent discharging nozzle 30 is disposed such that a discharge direction of the mold release agent solution from the mold release agent discharging nozzle 30 is a direction along a rotation direction of the main mold body 10.

In the illustrated example, the shape of the discharge opening of the mold release agent discharging nozzle 30 is the circular shape. However, in the invention, the shape of the discharge opening may be a shape that allows the mold release agent solution to be discharged. For example, it is possible to employ an oval shape, a rectangular shape, a shape in which a plurality of holes forms a straight line, etc. Among these respective shapes, the circular shape is preferable as the shape of the discharge opening in that a discharge pressure or a discharge pattern of the mold release agent is easily controlled.

In addition, while one mold release agent discharging nozzle 30 is shown in the illustrated example, two or more mold release agent discharging nozzles 30 may be used in the invention.

In addition, in the illustrated example, the mold release agent discharging nozzle 30 is disposed such that the mold release agent solution is attached to the lower half on the outer circumferential surface of the main mold body 10. However, in the invention, the mold release agent discharging nozzle 30 may be disposed such that the mold release agent solution is attached to an upper half on the outer circumferential surface of the main mold body 10. However, when the mold release agent discharging nozzle 30 is disposed such that the mold release agent solution is attached to the upper half on the outer circumferential surface of the main mold body 10, there is a concern that the mold release agent solution may flow down and drop to a region in which drying is completed (mold release agent layer) in the lower half on the outer circumferential surface of the main mold body 10, and thus irregularity in film thickness of the mold release agent layer may be generated. Therefore, it is preferable that the mold release agent discharging nozzle 30 be disposed such that the mold release agent solution discharged from the mold release agent discharging nozzle 30 is attached to the lower half on the outer circumferential surface of the main mold body 10.

In addition, in the illustrated example, the mold release agent discharging nozzle 30 is disposed such that the discharge direction of the mold release agent solution is a direction along the rotation direction of the main mold body 10 (forward direction). However, in the invention, the mold release agent discharging nozzle 30 may be disposed such that the discharge direction of the mold release agent solution is a direction opposite to the rotation direction of the main mold body 10 (reverse direction). It is preferable that the mold release agent discharging nozzle 30 be disposed such that the discharge direction of the mold release agent solution is the direction along the rotation direction of the main mold body 10 in that the mold release agent solution is rarely scattered, and a spread width w of the mold release agent solution is easily stabilized.

Gas Discharging Nozzle:

A shape of a discharge opening of the gas discharging nozzle 40 is a rectangular shape.

The gas discharging nozzle 40 is disposed in a rear of the mold release agent discharging nozzle 30 with respect to a movement direction of the mold release agent discharging nozzle 30.

In addition, the gas discharging nozzle 40 is located at a position higher than the mold release agent discharging nozzle 30 in the vertical direction, and is disposed such that gas having a certain width discharged from the gas discharging nozzle 40 is blown on a mold release agent solution positioned in the upper half on the outer circumferential surface of the main mold body 10.

In addition, the gas discharging nozzle 40 is disposed such that a discharge direction of gas from the gas discharging nozzle 40 is a direction opposite to the rotation direction of the main mold body 10.

While the shape of the discharge opening of the gas discharging nozzle 40 is the rectangular shape in the illustrated example, any shape that allows gas to be discharged may be used in the invention. For example, it is possible to employ a circular shape, an oval shape, a shape in which a plurality of holes forms a straight line, etc. Among these respective shapes, the rectangular shape which is long and narrow (slit shape) or the shape in which the plurality of holes forms the straight line is preferable as the shape of the discharge opening in that gas having the certain width is easily discharged.

In addition, while one gas discharging nozzle 40 is shown in the illustrated example, two or more gas discharging nozzles 40 may be used in the invention.

In addition, in the illustrated example, the gas discharging nozzle 40 is located at the position higher than the mold release agent discharging nozzle 30 in the vertical direction, and is disposed such that gas is blown on the mold release agent solution positioned in the upper half on the outer circumferential surface of the main mold body 10. However, in the invention, the gas discharging nozzle 40 may be located at a position lower than the mold release agent discharging nozzle 30 in the vertical direction, and may be disposed such that gas is blown on the mold release agent solution positioned in the lower half on the outer circumferential surface of the main mold body 10. However, when the gas discharging nozzle 40 is located at the position lower than the mold release agent discharging nozzle 30, and is disposed such that gas is blown on the mold release agent solution positioned in the lower half on the outer circumferential surface of the main mold body 10, there is a concern that the mold release agent solution discharged from the mold release agent discharging nozzle 30 may flow down and drop to the region in which drying is completed (mold release agent layer) in the lower half on the outer circumferential surface of the main mold body 10, and thus irregularity in film thickness of the mold release agent layer may be generated. Therefore, it is preferable that the gas discharging nozzle 40 be located at the position higher than the mold release agent discharging nozzle 30 in the vertical direction, and be disposed such that gas is blown on the mold release agent solution positioned in the upper half on the outer circumferential surface of the main mold body 10.

In addition, in the illustrated example, the gas discharging nozzle 40 is disposed such that the discharge direction of gas is the direction opposite to the rotation direction of the main mold body 10 (reverse direction). However, in the invention, the gas discharging nozzle 40 may be disposed such that the discharge direction of gas is the direction along the rotation direction of the main mold body 10 (forward direction). It is preferable that the gas discharging nozzle 40 be disposed such that the discharge direction of gas is the direction opposite to the rotation direction of the main mold body 10 in that the mold release agent solution on the outer circumferential surface of the main mold body 10 can be more efficiently dried.

In addition, it is preferable that the gas discharging nozzle 40 be disposed such that the discharge direction of gas is inclined with respect to the central axis of the main mold body 10. Specifically, an angle θ on the first end portion 10a side formed by the discharge direction of gas and the central axis of the main mold body 10 when viewed from above in the vertical direction illustrated in FIG. 2 is preferably greater than 0° and less than 90°, and more preferably in a range of 10 to 80°. When the angle θ is within the range, the mold release agent solution rarely flows to the region in which drying is completed (mold release agent layer) due to gas discharged from the gas discharging nozzle 40, and irregularity in film thickness of the mold release agent layer is rarely generated.

Moving Mechanism:

The moving mechanism 50 includes a nozzle fixture 52 that fixes the mold release agent discharging nozzle 30 and the gas discharging nozzle 40, and a linear guide 54 that moves the nozzle fixture 52 in parallel with the central axis of the main mold body 10.

The gas discharging nozzle 40 is fixed by the nozzle fixture 52 together with the mold release agent discharging nozzle 30, and thus may move to follow the mold release agent discharging nozzle 30.

In the illustrated example, the moving mechanism 50 moves the mold release agent discharging nozzle 30 and the gas discharging nozzle 40. However, in the invention, it is more preferable that the moving mechanism 50 relatively move the main mold body 10, the mold release agent discharging nozzle 30, and the gas discharging nozzle 40. For example, such a moving mechanism may move the main mold body 10 to intersect a front of the fixed mold release agent discharging nozzle 30 and gas discharging nozzle 40.

Control Means:

The control means (not illustrated) may be operated not to discharge the mold release agent solution toward the region in which drying is completed (mold release agent layer) from the mold release agent discharging nozzle 30 by controlling the moving mechanism 50. That is, even though the control means moves the mold release agent discharging nozzle 30 and the gas discharging nozzle 40 that follows the mold release agent discharging nozzle 30 from the first end portion 10a side to the second end portion 10b side of the main mold body 10 while the mold release agent solution is discharged from the mold release agent discharging nozzle 30, the control means may be operated to move the mold release agent discharging nozzle 30 and the gas discharging nozzle 40 which is ahead of the mold release agent discharging nozzle 30 from the second end portion 10b side to the first end portion 10a side of the main mold body 10.

In addition, the control means discharges the mold release agent solution toward the outer circumferential surface of the main mold body 10 from the mold release agent discharging nozzle 30 to attach the mold release agent solution to the outer circumferential surface in a region having a spread width w from the first end portion 10a and the first end portion 10a of the main mold body 10 in a state in which the mold release agent discharging nozzle 30 is not moved in the first end portion 10a of the main mold body 10 by controlling supply of the mold release agent solution to the mold release agent discharging nozzle 30, supply of gas to the gas discharging nozzle 40, and the moving mechanism 50. In addition, after a predetermined time passes from when the mold release agent solution starts to be discharged, the control means moves the mold release agent discharging nozzle 30 to discharge gas from the gas discharging nozzle 40 that follows the mold release agent discharging nozzle 30 toward the mold release agent solution attached to the outer circumferential surface of the first end portion 10a of the main mold body 10. When the control means (not illustrated) performs a control operation in this way, an initial retention time may be provided in a method of manufacturing a roll-shaped mold described below.

The above-described control means includes a processor (not illustrated), an interface unit (not illustrated), and a storage unit (not illustrated).

The interface unit electrically connects the processor to the rotating means 20, a means for supplying the mold release agent solution to the mold release agent discharging nozzle 30 (not illustrated), a means for supplying gas to the gas discharging nozzle 40 (not illustrated), and the moving means 50.

The processor controls each means based on settings stored in the storage unit (an initial retention time, a moving speed, a rotating speed, a discharge flow rate of the mold release agent solution, a pressure at the source of gas, etc.).

The above-described processor may be implemented by dedicated hardware. Alternatively, the processor may include a memory and a central processing unit (CPU), and load a program for implementing a function of the processor into the memory to execute the program, thereby implementing the function.

In addition, it is presumed that an input device, a display device, etc. are connected as peripheral equipment to the control means. Herein, the input device refers to an input device such as a display touch panel, a switch panel, or a keyboard, and the display device refers to a CRT, or a liquid crystal display.

(Method of Manufacturing Mold)

Hereinafter, a description will be given of a method of manufacturing a mold according to the first embodiment of the invention using the manufacturing apparatus 1 with reference to drawings.

The method of manufacturing the mold according to the first embodiment of the invention includes an attaching step (S1) below and a drying step (S2) below.

(S1) Step of attaching the mold release agent solution to the outer circumferential surface of the main mold body 10 by supplying the mold release agent solution to the outer circumferential surface of the main mold body 10 from the mold release agent discharging nozzle 30 disposed to be separated from the main mold body 10 while rotating the main mold body 10 using the central axis as the rotation axis in a state in which the main mold body 10 is held such that the central axis of the main mold body 10 is in the horizontal direction

(S2) Step of forming the mold release agent layer by drying the mold release agent solution by discharging gas toward the mold release agent solution attached to the outer circumferential surface of the main mold body 10 from the gas discharging nozzle 40 disposed to be separated from the main mold body 10 while rotating the main mold body 10 using the central axis as the rotation axis in a state in which the main mold body 10 is held such that the central axis of the main mold body 10 is in the horizontal direction

In the first embodiment, both the attaching step (S1) and the drying step (S2) are simultaneously performed.

However, when both the attaching step (S1) and the drying step (S2) are simultaneously performed, it is preferable not to discharge the mold release agent solution toward the region in which drying is completed (the mold release agent layer) from the mold release agent discharging nozzle 30, that is, not to apply the mold release agent solution twice.

Attaching step (S1) and drying step (S2)

(i) When the roll-shaped mold used for the nanoimprint method is manufactured, each step is preferably performed under a clean environment. When each step is performed under the clean environment, it is possible to inhibit dust, dirt, etc. from being sprayed on the outer circumferential surface of the main mold body 10 to cause a slight damage, and it is possible to inhibit a foreign substance, etc. from being attached to the outer circumferential surface of the main mold body 10 when gas is blown on the main mold body 10 from the gas discharging nozzle 40.

“Under the clean environment” in the invention refers to Class 1,000 or less in the FED standard, and Class 1,000 or less is preferable in that a foreign substance is more effectively inhibited from being attached.

(ii) The main mold body 10 is held by the main shaft-side holder 21 and the tail-side holder 22 such that the central axis of the main mold body 10 is in the horizontal direction.

In the illustrated example, the main mold body 10 is held such that the central axis of the main mold body 10 is in the horizontal direction. However, in the invention, the main mold body 10 may be held such that the central axis of the main mold body 10 is in a direction other than the vertical direction. For the above-described reason, when the main mold body 10 is held such that the central axis of the main mold body 10 is in a direction other than the vertical direction, irregularity in film thickness of the mold release agent layer is rarely generated at the first end portion 10a side and the second end portion 10b side of the main mold body 10. In addition, it is preferable that the main mold body 10 be held such that the central axis of the main mold body 10 is within ±10° with respect to the horizontal direction, and it is particularly preferable that the main mold body 10 be held such that the central axis of the main mold body 10 is in the horizontal direction.

(iii) The main mold body 10 is rotated using the central axis of the main mold body 10 as the rotation axis by the rotating mechanism 20. Rotation of the main mold body 10 is continued until formation of the mold release agent layer is fully completed.

(iv) The mold release agent solution is attached to the outer circumferential surface in the region having the spread width w from the first end portion 10a and the first end portion 10a of the main mold body 10 by discharging and supplying the mold release agent solution toward the outer circumferential surface of the main mold body 10 from the mold release agent discharging nozzle 30 disposed to be separated from the main mold body 10 in a state in which the mold release agent discharging nozzle 30 is not moved in the first end portion 10a of the main mold body 10.

After a predetermined time passes from when the mold release agent solution starts to be discharged, the mold release agent discharging nozzle 30 is moved to the second end portion 10b side of the main mold body 10 to discharge gas from the gas discharging nozzle 40 that follows the mold release agent discharging nozzle 30 toward the mold release agent solution attached to the outer circumferential surface of the first end portion 10a of the main mold body 10. In this way, the initial retention time may be provided.

Herein, when the mold release agent discharging nozzle 30 simultaneously starts to discharge the mold release agent solution and move the mold release agent discharging nozzle 30 from a position illustrated in FIG. 2, that is, a position at which the spread width w of the mold release agent solution is formed on the outer circumferential surface at the first end portion 10a of the main mold body 10 and a portion adjacent to the first end portion 10a, the mold release agent discharging nozzle 30 moves before the mold release agent solution is sufficiently attached to the outer circumferential surface of the first end portion 10a of the main mold body 10. Therefore, when the mold release agent discharging nozzle 30 starts to discharge the mold release agent solution at the position illustrated in FIG. 2, the initial retention time is provided to sufficiently attach the mold release agent solution to the outer circumferential surface of the first end portion 10a of the main mold body 10, thereby decreasing a difference in film thickness of the mold release agent layer between the first end portion 10a of the main mold body 10 and a region other than the first end portion 10a.

It is preferable that the initial retention time of the mold release agent discharging nozzle 30 satisfy a relation below. That is, when the spread width w of the mold release agent solution is 60 mm, the initial retention time is preferably 40 seconds or more and 600 seconds or less.

w×2/3≦T≦w×10

Herein, in the above inequality, T denotes the initial retention time [seconds], and w denotes the spread width w [mm] of the mold release agent solution.

When the initial retention time T is w×2/3 or more, the mold release agent solution is sufficiently attached to the first end portion 10a of the main mold body 10, and thus a difference in film thickness of the mold release agent layer between the first end portion 10a of the main mold body 10 and a place other than the first end portion 10a may be sufficiently reduced. When the initial retention time T is w×10 or less, the roll-shaped mold may be efficiently manufactured, and the film thickness of the mold release agent layer is not excessively thick at the first end portion 10a of the main mold body 10 and the portion adjacent to the first end portion 10a.

When the mold release agent discharging nozzle 30 simultaneously starts to discharge the mold release agent solution and move the mold release agent discharging nozzle 30 from a position at a rear of the first end portion 10a of the main mold body 10 in the movement direction of the mold release agent discharging nozzle 30, that is, a position at which the mold release agent solution is discharged toward the main shaft-side shaft 23 or the main shaft-side holder 21, the initial retention time may not be provided. However, in this case, there is a problem that the main shaft-side shaft 23 or the main shaft-side holder 21 is contaminated by the mold release agent, or the mold release agent solution discharged toward the main shaft-side shaft 23 or the main shaft-side holder 21 is wasted.

When the mold release agent solution is discharged from the mold release agent discharging nozzle 30, the mold release agent solution is discharged from the mold release agent discharging nozzle 30 in which the shape of the discharge opening is the circular shape.

In addition, when the mold release agent solution is discharged from the mold release agent discharging nozzle 30, the mold release agent solution is discharged toward the lower half on the outer circumferential surface of the main mold body 10, and the mold release agent solution is attached to the outer circumferential surface of the main mold body 10

In addition, when the mold release agent solution is discharged from the mold release agent discharging nozzle 30, the mold release agent solution is discharged such that the discharge direction of the mold release agent solution from the mold release agent discharging nozzle 30 is a direction along the rotation direction of the main mold body 10.

In the illustrated example, the mold release agent solution is discharged from the mold release agent discharging nozzle 30 in which the shape of the discharge opening is the circular shape. However, in the invention, for example, the mold release agent solution may be discharged from a mold release agent discharging nozzle in which a shape of a discharge opening is an oval shape, a rectangular shape, a shape in which a plurality of holes forms a straight line, etc. Among the above-described respective shapes, it is preferable that the mold release agent solution be discharged from the mold release agent discharging nozzle 30 in which the shape of the discharge opening is the circular shape for the above-described reason.

In addition, while the mold release agent solution is discharged from one mold release agent discharging nozzle 30 in the illustrated example, the mold release agent solution may be discharged from two or more mold release agent discharging nozzles 30 in the invention.

In addition, in the illustrated example, the mold release agent solution is discharged from the mold release agent discharging nozzle 30 toward the lower half on the outer circumferential surface of the main mold body 10. However, in the invention, the mold release agent solution may be discharged from the mold release agent discharging nozzle 30 toward the upper half on the outer circumferential surface of the main mold body 10. Meanwhile, for the above-described reason, it is preferable that the mold release agent solution be discharged from the mold release agent discharging nozzle 30 toward the lower half on the outer circumferential surface of the main mold body 10.

In addition, in the illustrated example, the mold release agent solution is discharged from the mold release agent discharging nozzle 30 such that the discharge direction of the mold release agent solution from the mold release agent discharging nozzle 30 is the direction along the rotation direction of the main mold body 10 (forward direction). However, in the invention, the mold release agent solution may be discharged from the mold release agent discharging nozzle 30 such that the discharge direction of the mold release agent solution from the mold release agent discharging nozzle 30 is the direction opposite to the rotation direction of the main mold body 10 (reverse direction). Meanwhile, for the above-described reason, it is preferable that the mold release agent solution be discharged from the mold release agent discharging nozzle 30 such that the discharge direction of the mold release agent solution from the mold release agent discharging nozzle 30 is the direction along the rotation direction of the main mold body 10.

A discharge flow rate of the mold release agent solution discharged from the mold release agent discharging nozzle 30 is not particularly restricted. However, for example, the discharge flow rate is preferably in a range of 400 to 800 mL/min per nozzle. When the discharge flow rate of the mold release agent solution is greater than or equal to 400 mL/min per nozzle, the mold release agent solution sufficiently arrives at the outer circumferential surface of the main mold body 10, and the mold release agent solution is sufficiently attached to the outer circumferential surface of the main mold body 10. Meanwhile, when the discharge flow rate of the mold release agent solution exceeds 800 mL/min per nozzle, there is a concern that the mold release agent solution attached to the outer circumferential surface of the main mold body 10 may be scattered and attached to the region in which drying is completed (mold release agent layer), and irregularity in film thickness of the mold release agent layer may be generated.

The number of mold release agent discharging nozzles 30 used for the manufacturing apparatus of the invention is not particularly restricted, and may be appropriately determined depending on a size of the main mold body 10, etc.

The spread width w of the mold release agent solution is preferably shorter than a length of the main mold body 10 in a direction of the central axis, more preferably less than or equal to half the length of the main mold body 10 in the direction of the central axis, and even more preferably the same level as a width of gas discharged from the gas discharging nozzle 40 in that the mold release agent solution can be efficiently attached to the outer circumferential surface of the main mold body 10.

A temperature of the mold release agent solution sprayed on the outer circumferential surface of the main mold body 10 is preferably in a range of 10 to 50° C., and more preferably in a range of 15 to 30° C. When the temperature of the mold release agent solution is less than 10° C., there is a possibility that dew condensation will occur on the outer circumferential surface of the main mold body 10, and there is a concern that application unevenness may be generated. When the temperature exceeds 50° C., there is a concern that the surface of the main mold body 10 may be excessively rapidly dried, and irregularity in film thickness of the mold release agent layer may be generated. When a material of the main mold body 10 is aluminum, if the temperature is less than or equal to 50° C., corrosion of aluminum may be suppressed.

Examples of the mold release agent solution include a solution obtained by dissolving the above-described mold release agent in a solvent.

A concentration of the mold release agent in the mold release agent solution is preferably in a range of 0.05 to 0.1% by mass with respect to a total mass of the mold release agent solution. When the mold release agent concentration is greater than or equal to 0.05% by mass, a mold release agent layer having a sufficient film thickness may be formed. In addition, when the mold release agent concentration is less than or equal to 0.1% by mass, foaming of the mold release agent solution is suppressed.

(v) In the first embodiment, the spread width w of the mold release agent solution discharged from the mold release agent discharging nozzle 30 and attached to the outer circumferential surface of the main mold body 10 is shorter than a length of the main mold body 10 in the direction of the central axis.

Therefore, to provide the initial retention time, after the mold release agent discharging nozzle 30, which has not been moved, starts to be moved, while the mold release agent discharging nozzle 30 is moved from the first end portion 10a to the second end portion 10b of the main mold body 10 in parallel with the central axis of the main mold body 10, the mold release agent solution is discharged toward the outer circumferential surface of the main mold body 10 from the mold release agent discharging nozzle 30 such that the spread width w of the mold release agent solution attached to the outer circumferential surface of the main mold body 10 corresponds to a predetermined width. In this way, the mold release agent solution is attached to the whole outer circumferential surface of the main mold body.

A moving speed of the mold release agent discharging nozzle 30 is preferably in a range of 1 to 5 mm/sec as a relative speed with respect to the main mold body 10. When the moving speed is greater than or equal to 1 mm/sec, the roll-shaped mold may be efficiently manufactured. In addition, when the moving speed is less than or equal to 5 mm/sec, a mold release agent layer having a sufficient film thickness may be formed.

A wetted time is preferably substantially the same across the whole main mold body 10 including a region to which the mold release agent solution is attached in the initial retention time in that a difference in film thickness of the mold release agent layer between the first end portion 10a side and the second end portion 10b side of the main mold body 10 is made small.

However, the mold release agent solution is attached to a circumference 10c of the outer circumferential surface of the main mold body 10 at which an end of the spread width w of the mold release agent solution illustrated in FIG. 2 (that is, a region to which the mold release agent solution is attached in the initial retention time) on the second end portion 10b side is positioned until an end of the spread width w of the mold release agent solution on the first end portion 10a side moves along with movement of the mold release agent discharging nozzle 30 as illustrated in FIG. 5. That is, a wetted time at the circumference 10c of the outer circumferential surface of the main mold body 10 is a sum of the initial retention time and a wetted time in a region other than the region to which the mold release agent solution is attached in the initial retention time.

Therefore, when the mold release agent discharging nozzle 30 starts to discharge the mold release agent solution at the position illustrated in FIG. 2, that is, the position at which the spread width w of the mold release agent solution is formed on the outer circumferential surface at the first end portion 10a of the main mold body 10 and a portion adjacent to the first end portion 10a, a wetted time is preferably substantially the same across the whole main mold body 10 except for the region to which the mold release agent solution is attached in the initial retention time.

In addition, the initial retention time is preferably shorter than a wetted time in a region other than the region to which the mold release agent solution is attached in the initial retention time in terms of reducing a difference in film thickness of the mold release agent layer between the region to which the mold release agent solution is attached in the initial retention time and a region other than the region on the outer circumferential surface of the main mold body 10.

The wetted time in the region other than the region to which the mold release agent solution is attached in the initial retention time is preferably in a range of 1 to 30 minutes, and more preferably in a range of 1 to 10 minutes. When the wetted time is greater than or equal to 1 minute, a mold release agent layer having a sufficient film thickness can be formed. In addition, when the wetted time is less than or equal to 30 minutes, the film thickness of the mold release agent layer is not excessively thick, and application unevenness is suppressed.

(vi) To provide the initial retention time, after the mold release agent discharging nozzle 30, which has not been moved, starts to be moved, while the gas discharging nozzle 40 disposed at a rear of the mold release agent discharging nozzle 30 in the movement direction of the mold release agent discharging nozzle 30 is moved such that the gas discharging nozzle 40 follows the mold release agent discharging nozzle 30, gas is discharged toward the mold release agent solution attached to the outer circumferential surface of the main mold body 10 from the gas discharging nozzle 40. In this instance, the mold release agent solution is discharged and supplied toward the outer circumferential surface of the main mold body 10 from the mold release agent discharging nozzle 30 such that the spread width w of the mold release agent solution attached to the outer circumferential surface of the main mold body 10 becomes a predetermined width, and gas having the predetermined width is discharged toward the mold release agent solution attached to the outer circumferential surface of the main mold body 10 from the gas discharging nozzle 40. In this way, the mold release agent solution may be dried continuously after attaching the mold release agent solution at the same speed as that at which the mold release agent solution is attached.

When gas is discharged from the gas discharging nozzle 40, gas is discharged from the gas discharging nozzle 40 in which a shape of a discharge opening is a rectangular shape.

In addition, when gas is discharged from the gas discharging nozzle 40, gas is discharged toward the mold release agent solution attached to the outer circumferential surface of the main mold body 10 and positioned in the upper half on the outer circumferential surface of the main mold body 10 from the gas discharging nozzle 40 positioned higher than the mold release agent discharging nozzle 30 in the vertical direction.

In addition, when gas is discharged from the gas discharging nozzle 40, gas is discharged toward the mold release agent solution attached to the outer circumferential surface of the main mold body 10 such that the discharge direction of gas from the gas discharging nozzle 40 is a direction opposite to the rotation direction of the main mold body 10.

In the illustrated example, gas is discharged from the gas discharging nozzle 40 in which the shape of the discharge opening is the rectangular shape. However, in the invention, for example, gas may be discharged from a gas discharging nozzle in which a shape of a discharge opening is a circular shape, a rectangular shape, a shape in which a plurality of holes forms a straight line. Among the above-described respective shapes, for the above-described reason, it is preferable that gas be discharged from the gas discharging nozzle 40 in which the shape of the discharge opening is the rectangular shape which is long and narrow (slit shape) or the shape in which the plurality of holes forms the straight line.

In addition, while gas is discharged from one gas discharging nozzle 40 in the illustrated example, gas may be discharged from two or more gas discharging nozzles 40 in the invention.

In addition, in the illustrated example, gas is discharged toward the mold release agent solution positioned in the upper half on the outer circumferential surface of the main mold body 10 from the gas discharging nozzle 40 positioned higher than the mold release agent discharging nozzle 30 in the vertical direction. However, in the invention, gas may be discharged toward the mold release agent solution positioned in the lower half on the outer circumferential surface of the main mold body 10 from the gas discharging nozzle 40 positioned lower than the mold release agent discharging nozzle 30. In addition, for the above-described reason, it is preferable that gas be discharged toward the mold release agent solution positioned in the upper half on the outer circumferential surface of the main mold body 10 from the gas discharging nozzle 40 positioned higher than the mold release agent discharging nozzle 30 in the vertical direction.

In addition, in the illustrated example, gas is discharged from the gas discharging nozzle 40 such that the discharge direction of gas from the gas discharging nozzle 40 is the direction opposite to the rotation direction of the main mold body 10 (reverse direction). However, in the invention, gas may be discharged from the gas discharging nozzle 40 such that the discharge direction of gas from the gas discharging nozzle 40 is the direction along the rotation direction of the main mold body 10 (forward direction). For the above-described reason, it is preferable that gas be discharged from the gas discharging nozzle 40 such that the discharge direction of gas from the gas discharging nozzle 40 is the direction opposite to the rotation direction of the main mold body 10.

In addition, for the above-described reason, it is preferable that gas be discharged from the gas discharging nozzle 40 such that the discharge direction of gas from the gas discharging nozzle 40 is inclined with respect to the central axis of the main mold body 10. Specifically, an angle θ on the first end portion 10a side formed by the discharge direction of gas and the central axis of the main mold body 10 when viewed from above in the vertical direction illustrated in FIG. 2 is preferably greater than 0° and less than 90°, and more preferably in a range of 10 to 80°.

A pressure of gas discharged from the gas discharging nozzle 40 is preferably in a range of 0.3 MPa to 0.6 MPa, and more preferably in a range of 0.4 MPa to 0.6 MPa. When the pressure of gas is greater than or equal to 0.3 MPa, the mold release agent solution attached to the outer circumferential surface of the main mold body 10 may be dried without causing irregularity in film thickness of the mold release agent layer. In addition, the gas discharging nozzle 40 and the main mold body 10 may not be put close to each other more than necessary, and thus contact between the gas discharging nozzle 40 and the main mold body 10 may be prevented. On the other hand, when the pressure of gas exceeds 0.6 MPa, there is a concern that the mold release agent solution attached to the outer circumferential surface of the main mold body 10 may be scattered and attached to the region in which drying is completed (mold release agent layer), and irregularity in film thickness of the mold release agent layer may be generated.

A width of gas discharged from the gas discharging nozzle 40 is preferably shorter than the length of the main mold body 10 in the direction of the central axis, more preferably less than or equal to half the length of the main mold body 10 in the direction of the central axis, and even more preferably the same level as the spread width w of the mold release agent solution in that gas can be efficiently blown on the outer circumferential surface of the main mold body 10.

A temperature of gas blown on the outer circumferential surface of the main mold body 10 is preferably in a range of 10 to 50° C., and more preferably in a range of 15 to 30° C. When the temperature of gas is less than 10° C., there is a possibility that dew condensation will occur on the outer circumferential surface of the main mold body 10, and there is a concern that application unevenness may be generated. In addition, when the temperature exceeds 50° C., there is a concern that the surface of the main mold body 10 may be excessively rapidly dried, and irregularity in film thickness of the mold release agent layer may be generated. When the material of the main mold body 10 is aluminum, if the temperature of gas is less than or equal to 50° C., corrosion of aluminum may be suppressed.

(vii) In the first embodiment, it is preferable not to discharge the mold release agent solution toward the region in which drying is completed (mold release agent layer) from the mold release agent discharging nozzle 30. That is, even though the mold release agent discharging nozzle 30 and the gas discharging nozzle 40 that follows the mold release agent discharging nozzle 30 are moved from the first end portion 10a side to the second end portion 10b side of the main mold body 10 in parallel with the central axis of the main mold body 10 while the mold release agent solution is discharged from the mold release agent discharging nozzle 30, the mold release agent discharging nozzle 30 and the gas discharging nozzle 40 which is ahead of the mold release agent discharging nozzle 30 are not moved from the second end portion 10b side to the first end portion 10a side of the main mold body 10.

(Action Mechanism)

In the above-described first embodiment, the mold release agent solution is discharged and supplied toward the outer circumferential surface of the main mold body 10 from the mold release agent discharging nozzle 30 to attach the mold release agent solution to the outer circumferential surface of the main mold body 10 while the main mold body 10 is rotated. Thus, stripe-shaped application unevenness is rarely generated when compared to a case in which the mold release agent solution is directly applied to the outer circumferential surface of the main mold body.

In addition, since the mold release agent solution attached to the outer circumferential surface of the main mold body 10 is dried by discharging gas toward the mold release agent solution from the gas discharging nozzle 40 while the main mold body 10 is rotated, the mold release agent solution which is excessively attached for a short period of time may be removed when compared to a case in which the main mold body is immersed in the mold release agent solution and taken out at an ultra-low speed. In addition, when the excessively attached mold release agent solution is removed by discharging gas, the film thickness of the mold release agent solution may be uniform, and stripe-shaped application unevenness, a drip, etc. may be removed.

In addition, when the main mold body 10 is rotated using the central axis as the rotation axis while the main mold body 10 is held such that the central axis of the main mold body 10 is in a direction other than the vertical direction, irregularity in film thickness of the mold release agent layer is rarely generated at the first end portion 10a side and the second end portion 10b side of the main mold body 10 when compared to a case in which the central axis of the main mold body 10 is in the vertical direction. In addition, when the main mold body 10 is rotated in the above-described position, application unevenness due to a drip is rarely generated, and facility design at the time of manufacturing a large roll-shaped mold becomes relatively easy.

In addition, since the mold release agent solution is not discharged toward the region in which drying is completed (mold release agent layer) from the mold release agent discharging nozzle 30, irregularity in film thickness of the mold release agent layer due to two coats is not generated.

From the above, according to the first embodiment, it is possible to efficiently manufacture a roll-shaped mold in which irregularity in film thickness of a mold release agent layer is suppressed even when a main mold body increases in size. In particular, it is suitable for manufacturing a roll-shaped mold having a nano-order microrelief structure, in which a remarkable influence of irregularity in film thickness of the mold release agent layer is easily exhibited, on an outer circumferential surface.

In addition, in the above-described first embodiment, while the mold release agent discharging nozzle 30 is moved from the first end portion 10a to the second end portion 10b in parallel with the central axis of the main mold body 10, the mold release agent solution is discharged toward the outer circumferential surface of the main mold body 10 from the mold release agent discharging nozzle 30. At the same time, while the gas discharging nozzle 40 disposed at a rear of the mold release agent discharging nozzle 30 in the movement direction of the mold release agent discharging nozzle 30 is moved such that the gas discharging nozzle 40 follows the mold release agent discharging nozzle 30, gas is discharged toward the mold release agent solution attached to the outer circumferential surface of the main mold body 10 from the gas discharging nozzle 40. For this reason, irregularity in wetted time is reduced across the whole outer circumferential surface of the main mold body 10, and irregularity in film thickness of the mold release agent layer is further suppressed.

Further, the mold release agent solution is dried continuously after attaching the mold release agent solution at the same speed as that at which the mold release agent solution is attached by discharging gas having a predetermined width toward the mold release agent solution attached to the outer circumferential surface of the main mold body 10 from the gas discharging nozzle 40 simultaneously with discharging the mold release agent solution toward the outer circumferential surface of the main mold body 10 from the mold release agent discharging nozzle 30 such that the spread width w of the mold release agent solution attached to the outer circumferential surface of the main mold body 10 corresponds to the predetermined width. For this reason, irregularity in wetted time is further reduced across the whole outer circumferential surface of the main mold body 10, and irregularity in film thickness of the mold release agent layer is further suppressed.

In addition, in the above-described first embodiment, the mold release agent solution is discharged toward the outer circumferential surface of the main mold body 10 from the mold release agent discharging nozzle 30 while the mold release agent discharging nozzle 30 is not moved in the first end portion 10a of the main mold body 10 to attached the mold release agent solution to the outer circumferential surface in the first end portion 10a and a portion adjacent to the first end portion 10a. After a predetermined time passes from when the mold release agent solution starts to be discharged, the mold release agent discharging nozzle 30 is moved to discharge gas toward the mold release agent solution attached to the outer circumferential surface in the first end portion 10a from the gas discharging nozzle 40 that follows the mold release agent discharging nozzle 30. For this reason, the mold release agent solution may be sufficiently attached to the outer circumferential surface in the first end portion 10a of the main mold body 10. As a result, it is possible to reduce a difference in film thickness of the mold release agent layer between the first end portion 10a of the main mold body 10 and a region other than the first end portion 10a.

In addition, in the above-described first embodiment, the mold release agent solution is discharged and supplied toward the lower half on the outer circumferential surface of the main mold body 10 from the mold release agent discharging nozzle 30 to attach the mold release agent solution to the outer circumferential surface of the main mold body 10. At the same time, gas having a predetermined width is discharged toward the mold release agent solution attached to the outer circumferential surface of the main mold body 10 and positioned in the upper half on the outer circumferential surface of the main mold body 10 from the gas discharging nozzle 40 positioned higher than the mold release agent discharging nozzle 30 in the vertical direction. For this reason, there is no concern that the mold release agent solution discharged from the mold release agent discharging nozzle 30 may flow down and drop to the region in which drying is completed (mold release agent layer) in the lower half on the outer circumferential surface of the main mold body 10, and thus irregularity in film thickness of the mold release agent layer may be generated.

In addition, in the above-described first embodiment, gas is discharged toward the mold release agent solution attached to the outer circumferential surface of the main mold body 10 from the gas discharging nozzle 40 such that the discharge direction of gas from the gas discharging nozzle 40 corresponds to a direction opposite to the rotation direction of the main mold body 10. For this reason, the mold release agent solution on the outer circumferential surface of the main mold body 10 may be more efficiently dried.

### Second Embodiment

### Apparatus for Manufacturing Roll-Shaped Mold

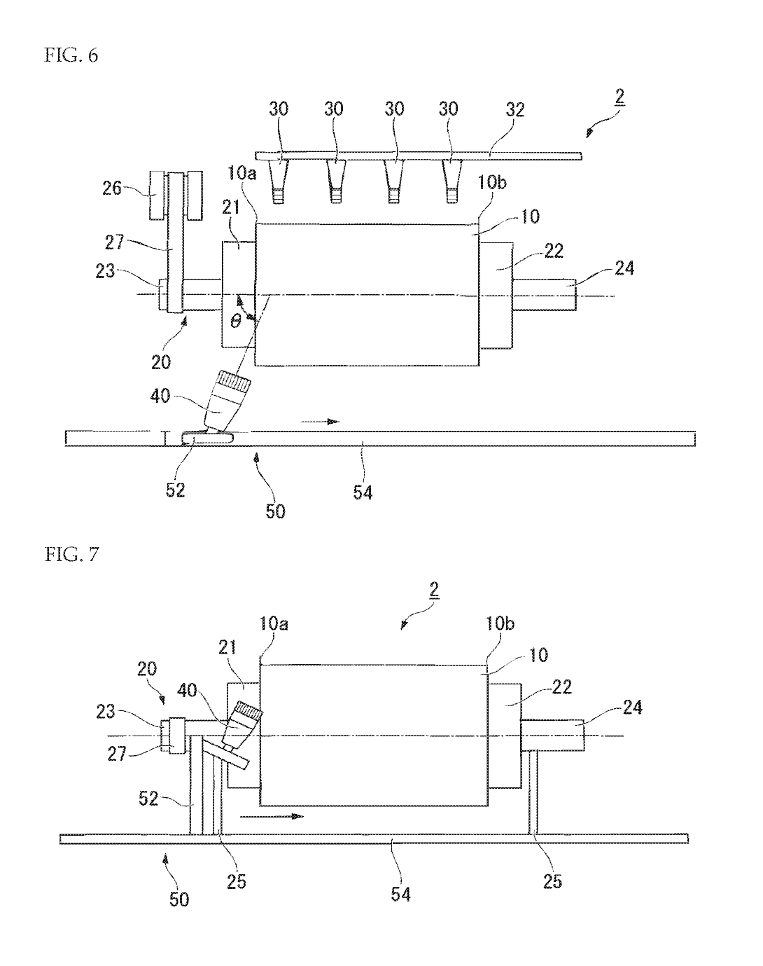

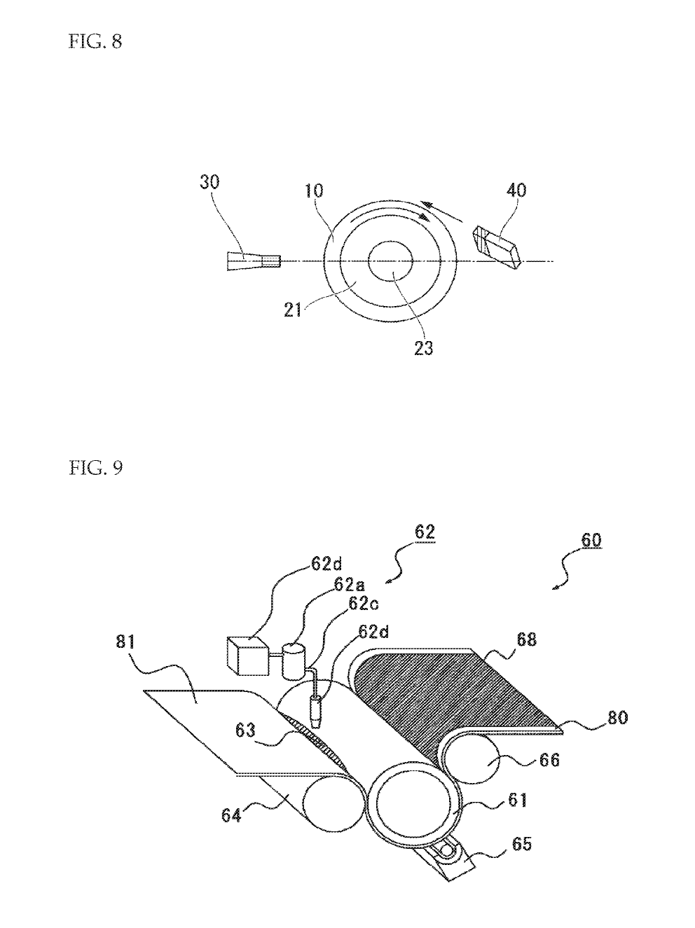

FIG. 6 is a top view illustrating an apparatus for manufacturing a roll-shaped mold used in a second embodiment of the invention, FIG. 7 is a front view illustrating the manufacturing apparatus of FIG. 6 when viewed in a horizontal direction, and FIG. 8 is a side view of a portion of the manufacturing apparatus of FIG. 6 when viewed in a central axis direction of a main mold body.

A manufacturing apparatus 2 includes a rotating mechanism 20 for rotating a roll-shaped main mold body 10 using a central axis of the main mold body 10 as a rotation axis while the main mold body 10 is held such that the central axis of the main mold body 10 is in the horizontal direction, a plurality of mold release agent discharging nozzles 30 (mold release agent discharging means) disposed to be separated from the main mold body 10 to discharge and supply a mold release agent solution toward an outer circumferential surface of the main mold body 10, thereby attaching the mold release agent solution to the outer circumferential surface of the main mold body 10, a gas discharging nozzle 40 (gas discharging means) disposed to be separated from the main mold body 10 to discharge gas toward the mold release agent solution attached to the outer circumferential surface of the main mold body 10, thereby drying the mold release agent solution to form a mold release agent layer, a moving mechanism 50 for moving the gas discharging nozzle 40 in parallel with the central axis of the main mold body 10, and a control means (not illustrated) for not discharging the mold release agent solution toward a region in which drying is completed (the mold release agent layer) from the mold release agent discharging nozzle 30 by controlling supply of the mold release agent solution to the plurality of mold release agent discharging means.

Hereinafter, the same reference numeral will be assigned to a component having the same configuration as that in the first embodiment, and a detailed description thereof will be omitted.

Rotating Mechanism:

The rotating mechanism 20 has the same configuration as that in the first embodiment.

Mold Release Agent Discharging Nozzle:

The mold release agent discharging nozzle 30 is the same nozzle as that in the first embodiment.

However, in the second embodiment, the plurality of mold release agent discharging nozzles 30 is arranged side by side at equal intervals along a longitudinal direction of the main mold body 10 on an opposite side from the gas discharging nozzle 40 with the main mold body 10 interposed therebetween, and is fixed to the nozzle fixture 32.

In addition, the plurality of mold release agent discharging nozzles 30 is disposed such that the mold release agent solution discharged from the mold release agent discharging nozzles 30 is attached to a center of the outer circumferential surface of the main mold body 10 in a vertical direction.

In an illustrated example, the mold release agent discharging nozzles 30 are disposed such that the mold release agent solution is attached to the center of the outer circumferential surface of the main mold body 10 in the vertical direction. However, in the invention, the mold release agent discharging nozzles 30 may be disposed such that the mold release agent solution is attached to an upper half on the outer circumferential surface of the main mold body 10, or such that the mold release agent solution is attached to a lower half on the outer circumferential surface of the main mold body 10.

In addition, while four mold release agent discharging nozzles 30 are shown in the illustrated example, the number of mold release agent discharging nozzles 30 may be appropriately determined depending on a length of the main mold body 10 in the longitudinal direction, etc.

In addition, in the illustrated example, the mold release agent discharging means is presumed to be the plurality of mold release agent discharging nozzles 30 arranged side by side at equal intervals along the longitudinal direction of the main mold body 10. However, in the invention, for example, the mold release agent discharging means may be presumed to be one mold release agent discharging nozzle having a slit, a length of which is substantially the same as a length of the main mold body 10 in a lengthwise direction.

Gas Discharging Nozzle:

The gas discharging nozzle 40 is the same nozzle as that in the first embodiment.

However, in the second embodiment, the gas discharging nozzle 40 is disposed on the opposite side from the mold release agent discharging nozzle 30 with the main mold body 10 interposed therebetween.

A position at which the gas discharging nozzle 40 is disposed, a discharge direction of gas from the gas discharging nozzle 40, and preferred modes thereof are the same as those in the first embodiment.

Moving Mechanism:

The moving mechanism 50 includes a nozzle fixture 52 that fixes the gas discharging nozzle 40, and a linear guide 54 that moves the nozzle fixture 52 in parallel with the central axis of the main mold body 10.

The moving mechanism 50 is the same as that in the first embodiment except that the mold release agent discharging nozzles 30 are not fixed to the nozzle fixture 52.

Control Means:

The control means (not illustrated) may be operated not to discharge the mold release agent solution toward the region in which drying is completed (mold release agent layer) from the mold release agent discharging nozzle 30 by controlling supply of the mold release agent solution to the plurality of mold release agent discharging means. That is, the control means may be operated not to discharge the mold release agent solution toward the outer circumferential surface of the main mold body 10 from the plurality of mold release agent discharging nozzles 30 while gas is discharged toward the mold release agent solution attached to the outer circumferential surface of the main mold body 10 from the gas discharging nozzle 40 and after drying of the mold release agent solution ends after the mold release agent solution is discharged toward the outer circumferential surface of the main mold body 10 simultaneously from the plurality of mold release agent discharging nozzles 30 arranged side by side at equal intervals along the longitudinal direction of the main mold body 10.

The control means has the same configuration as that in the first embodiment except for a function of a processor.

(Method of Manufacturing Mold)

Hereinafter, a description will be given of a method of manufacturing a mold according to the second embodiment of the invention using the manufacturing apparatus 2.

The method of manufacturing the mold according to the second embodiment of the invention includes an attaching step (S1) below and a drying step (S2) below.

(S1) Step of attaching the mold release agent solution to the whole outer circumferential surface of the main mold body 10 by discharging and supplying the mold release agent solution toward the outer circumferential surface of the main mold body 10 simultaneously from the plurality of mold release agent discharging nozzles 30 disposed to be separated from the main mold body 10 while rotating the main mold body 10 using the central axis as the rotation axis in a state in which the main mold body 10 is held such that the central axis of the main mold body 10 is in the horizontal direction

(S2) Step of forming the mold release agent layer by drying the mold release agent solution by discharging gas toward the mold release agent solution attached to the outer circumferential surface of the main mold body 10 from the gas discharging nozzle 40 disposed to be separated from the main mold body 10 while rotating the main mold body 10 using the central axis as the rotation axis in a state in which the main mold body 10 is held such that the central axis of the main mold body 10 is in the horizontal direction

In the second embodiment, the attaching step (S1) is first performed, and then the drying step (S2) is performed.

It is preferable not to discharge the mold release agent solution toward the region in which drying is completed (mold release agent layer) from the mold release agent discharging nozzles 30, that is, not to apply the mold release agent solution twice during and after the drying step (S2).

Hereinafter, when an operation and a preferred mode are the same as those in the first embodiment, a detailed description thereof will be omitted.

Attaching Step (S1) and Drying Step (S2):

(i) When the roll-shaped mold which is used for a nanoimprint method is manufactured, each step is preferably performed under a clean environment.

(ii) The main mold body 10 is held by a main shaft-side holder 21 and a tail-side holder 22 such that the central axis of the main mold body 10 is in the horizontal direction.

(iii) The main mold body 10 is rotated using the central axis of the main mold body 10 as the rotation axis by the rotating mechanism 20. Rotation of the main mold body 10 is continued until formation of the mold release agent layer is fully completed.

(iv) The mold release agent solution is attached to the whole outer circumferential surface of the main mold body 10 by discharging and supplying the mold release agent solution toward the outer circumferential surface of the main mold body 10 simultaneously from the plurality of mold release agent discharging nozzles 30 arranged side by side at equal intervals along the longitudinal direction of the main mold body 10.

In the illustrated example, the mold release agent solution is discharged simultaneously from the plurality of mold release agent discharging nozzles 30 arranged side by side at equal intervals along the longitudinal direction of the main mold body 10. However, in the invention, for example, the mold release agent solution may be discharged from one mold release agent discharging nozzle having a slit, a length of which is substantially the same as the length of the main mold body 10 in the lengthwise direction.

(v) Gas is discharged toward the mold release agent solution attached to the outer circumferential surface of the main mold body 10 from the gas discharging nozzle 40 while the gas discharging nozzle 40 is moved from the first end portion 10a to the second end portion 10b of the main mold body 10 along the longitudinal direction of the main mold body 10.

(vi) In the second embodiment, it is preferable not to discharge the mold release agent solution toward the region in which drying is completed (mold release agent layer) from the mold release agent discharging nozzles 30. That is, it is preferable not to discharge the mold release agent solution toward the outer circumferential surface of the main mold body 10 from the plurality of mold release agent discharging nozzles 30 arranged side by side at equal intervals along the longitudinal direction of the main mold body 10 while gas is discharged toward the mold release agent solution attached to the outer circumferential surface of the main mold body 10 from the gas discharging nozzle 40 and after drying of the mold release agent solution is completed after the mold release agent solution is discharged toward the outer circumferential surface of the main mold body 10 simultaneously from the plurality of mold release agent discharging nozzles 30.

(Action Mechanism)

In the above-described second embodiment, the mold release agent solution is discharged and supplied toward the outer circumferential surface of the main mold body 10 from the mold release agent discharging nozzles 30 to attach the mold release agent solution to the outer circumferential surface of the main mold body 10 while the main mold body 10 is rotated. Thus, stripe-shaped application unevenness is rarely generated when compared to a case in which the mold release agent solution is directly applied to the outer circumferential surface of the main mold body.

In addition, since the mold release agent solution attached to the outer circumferential surface of the main mold body 10 is dried by discharging gas toward the mold release agent solution from the gas discharging nozzle 40 while the main mold body 10 is rotated, the mold release agent solution which is excessively attached for a short period of time may be removed when compared to a case in which the main mold body is immersed in the mold release agent solution and taken out at an ultra-low speed. In addition, when the excessively attached mold release agent solution is removed by discharging gas, the film thickness of the mold release agent solution may be uniform, and stripe-shaped application unevenness, a drip, etc. may be removed.

In addition, since the main mold body 10 is rotated using the central axis as the rotation axis in a state in which the main mold body 10 is held such that the central axis of the main mold body 10 is in a direction other than the vertical direction, irregularity in film thickness of the mold release agent layer is rarely generated at the first end portion 10a side and the second end portion 10b side of the main mold body 10 when compared to a case in which the central axis of the main mold body 10 is in the vertical direction. In addition, when the main mold body 10 is rotated in the above-described position, application unevenness due to a drip is rarely generated, and facility design at the time of manufacturing a large roll-shaped mold becomes relatively easy.

In addition, since the mold release agent solution is not discharged toward the region in which drying is completed (mold release agent layer) from the mold release agent discharging nozzle 30, irregularity in film thickness of the mold release agent layer due to two coats is not generated.

From the above, according to the second embodiment, it is possible to efficiently manufacture a roll-shaped mold in which irregularity in film thickness of a mold release agent layer is suppressed even when a main mold body increases in size. In particular, it is suitable for manufacturing a roll-shaped mold having a nano-order microrelief structure, in which a remarkable influence of irregularity in film thickness of the mold release agent layer is easily exhibited, on an outer circumferential surface.

In addition, in the above-described second embodiment, since the mold release agent discharging nozzles 30 may not be moved, movable parts of the manufacturing apparatus 2 may be reduced, and a configuration of the apparatus may be simplified.

In addition, in the above-described second embodiment, gas is discharged toward the mold release agent solution attached to the outer circumferential surface of the main mold body 10 from the gas discharging nozzle 40 while the gas discharging nozzle 40 is moved from the first end portion 10a to the second end portion 10b along the longitudinal direction of the main mold body 10. For this reason, irregularity in film thickness of the mold release agent layer is further suppressed across the whole outer circumferential surface of the main mold body 10.

In addition, in the above-described second embodiment, gas having a predetermined width is discharged toward the mold release agent solution attached to the outer circumferential surface of the main mold body 10 and positioned in the upper half on the outer circumferential surface of the main mold body 10 from the gas discharging nozzle 40 positioned higher than the mold release agent discharging nozzles 30. For this reason, the mold release agent solution may be inhibited from scattering and dropping to a region dried by being supplied with gas, and irregularity in film thickness may be inhibited from being generated.

In addition, in the above-described second embodiment, gas is discharged toward the mold release agent solution attached to the outer circumferential surface of the main mold body 10 from the gas discharging nozzle 40 such that the discharge direction of gas from the gas discharging nozzle 40 corresponds to a direction opposite to the rotation direction of the main mold body 10. For this reason, the mold release agent solution on the outer circumferential surface of the main mold body 10 may be more efficiently dried.

### Third Embodiment

### Apparatus for Manufacturing Roll-Shaped Mold

A manufacturing apparatus of a third embodiment is the same as the manufacturing apparatus 2 of the second embodiment except for a control means.

Control Means:

The control means (not illustrated) may be operated not to discharge the mold release agent solution toward the region in which drying is completed (mold release agent layer) from the mold release agent discharging nozzles 30 by controlling supply of the mold release agent solution to the plurality of mold release agent discharging means. That is, the control means may be operated not to discharge the mold release agent solution from a mold release agent discharging nozzle 30 corresponding to the region in which drying is completed (mold release agent layer) while the mold release agent solution is discharged toward the outer circumferential surface of the main mold body 10 in order from a mold release agent discharging nozzle 30 on the first end portion 10a side of the main mold body 10 among the plurality of mold release agent discharging nozzles 30 arranged side by side at equal intervals along the longitudinal direction of the main mold body 10, and gas is discharged toward the mold release agent solution attached to the outer circumferential surface of the main mold body 10 from the gas discharging nozzle 40.

A configuration of the control means is the same as that in the second embodiment except for a function of a processor.

(Method of Manufacturing Mold)

Hereinafter, a description will be given of a method of manufacturing a mold according to a third embodiment of the invention using the manufacturing apparatus 2.

The method of manufacturing the mold according to the third embodiment of the invention includes an attaching step (S1) below and a drying step (S2) below.

(S1) Step of attaching the mold release agent solution to the whole outer circumferential surface of the main mold body 10 by gradually discharging and supplying the mold release agent solution toward the outer circumferential surface of the main mold body 10 in order from a mold release agent discharging nozzle 30 on the first end portion 10a side of the main mold body 10 among the plurality of mold release agent discharging nozzles 30 disposed to be separated from the main mold body 10 while rotating the main mold body 10 using the central axis as the rotation axis in a state in which the main mold body 10 is held such that the central axis of the main mold body 10 is in the horizontal direction

(S2) Step of forming the mold release agent layer by drying the mold release agent solution by discharging gas toward the mold release agent solution attached to the outer circumferential surface of the main mold body 10 from the gas discharging nozzle 40 disposed to be separated from the main mold body 10 while rotating the main mold body 10 using the central axis as the rotation axis in a state in which the main mold body 10 is held such that the central axis of the main mold body 10 is in the horizontal direction

In the third embodiment, the attaching step (S1) and the drying step (S2) are alternately performed.

However, when the attaching step (S1) and the drying step (S2) are alternately performed, it is preferable that the mold release agent solution not be discharged toward the region in which drying is completed (mold release agent layer) from the mold release agent discharging nozzles 30, that is, the mold release agent solution not be applied twice.

Hereinafter, when an operation and a preferred mode are the same as those in the first embodiment and the second embodiment, a detailed description thereof will be omitted.

Attaching Step (S1) and Drying Step (S2):

(i) When the roll-shaped mold which is used for a nanoimprint method is manufactured, each step is preferably performed under a clean environment.

(ii) The main mold body 10 is held by a main shaft-side holder 21 and a tail-side holder 22 such that the central axis of the main mold body 10 is in the horizontal direction.

(iii) The main mold body 10 is rotated using the central axis of the main mold body 10 as the rotation axis by the rotating mechanism 20. Rotation of the main mold body 10 is continued until formation of the mold release agent layer is fully completed.

(iv) The mold release agent solution is attached to the outer circumferential surface of the main mold body 10 by discharging and supplying the mold release agent solution toward the outer circumferential surface of the main mold body 10 from a first mold release agent discharging nozzle 30 from the first end portion 10a side of the main mold body 10 among the plurality of mold release agent discharging nozzles 30 arranged side by side at equal intervals along the longitudinal direction of the main mold body 10.

(v) The gas discharging nozzle 40 is moved to a portion, in which the mold release agent solution is attached to the outer circumferential surface of the main mold body 10, along the longitudinal direction of the main mold body 10, and gas is discharged toward the mold release agent solution attached to the outer circumferential surface of the main mold body 10 from the gas discharging nozzle 40.

(vi) Subsequently, the mold release agent solution is attached to the outer circumferential surface of the main mold body 10 by discharging and supplying the mold release agent solution toward the outer circumferential surface of the main mold body 10 from a mold release agent discharging nozzle 30 adjacent to the mold release agent discharging nozzle 30, from which the mold release agent solution has been previously discharged, on the second end portion 10b side of the main mold body 10.

(vii) The gas discharging nozzle 40 is moved to the portion, in which the mold release agent solution is attached to the outer circumferential surface of the main mold body 10, along the longitudinal direction of the main mold body 10, and gas is discharged toward the mold release agent solution attached to the outer circumferential surface of the main mold body 10 from the gas discharging nozzle 40.

The mold release agent layer is formed on the whole outer circumferential surface of the main mold body 10 by repeating operations (vi) and (vii).

In the illustrated example, the mold release agent solution is discharged in order from the plurality of mold release agent discharging nozzles 30 arranged side by side at equal intervals along the longitudinal direction of the main mold body 10. However, in the invention, for example, the mold release agent solution may be partially discharged from one mold release agent discharging nozzle having a slit, a length of which is substantially the same as the length of the main mold body 10 in the lengthwise direction.

(viii) In the third embodiment, it is preferable not to discharge the mold release agent solution toward the region in which drying is completed (mold release agent layer) from the mold release agent discharging nozzles 30. That is, even though gas is discharged toward the mold release agent solution attached to the outer circumferential surface of the main mold body 10 from the gas discharging nozzle 40 while the mold release agent solution is gradually attached to the outer circumferential surface of the main mold body 10 by discharging the mold release agent solution toward the outer circumferential surface of the main mold body 10 in order from the mold release agent discharging nozzle 30 on the first end portion 10a side of the main mold body 10 among the plurality of mold release agent discharging nozzles 30 arranged side by side at equal intervals along the longitudinal direction of the main mold body 10, it is preferable not to discharge the mold release agent solution from the mold release agent discharging nozzle 30 corresponding to the region in which drying is completed (mold release agent layer).

(Action Mechanism)

The above-described third embodiment exhibits the same effect as that of the second embodiment by the same action mechanism as that of the above-described second embodiment.

### Another Embodiment

The invention is not restricted to the first embodiment, the second embodiment, and the third embodiment, and may be variously modified within the scope not departing from the subject matter of the invention.

<Use of Roll-Shaped Mold>

For example, the roll-shaped mold obtained using the manufacturing method of the invention is used for formation of a microrelief structure on a surface of an article using a nanoimprint method, embossing formation on a surface of an article, bit formation on a surface of a recording medium, etc.

In the roll-shaped mold obtained using the manufacturing method of the invention, irregularity in film thickness of the mold release agent layer is small. Thus, when a shape of the outer circumferential surface of the roll-shaped mold is transferred to a surface of an article, irregularity is rarely generated in a shape of the surface of the article, and the obtained article has excellent appearance and performance.

In particular, the roll-shaped mold having the nano-order microrelief structure on the outer circumferential surface is suitable as a roll-shaped mold for a nanoimprint in which a remarkable influence of irregularity in film thickness of the mold release agent layer is easily exhibited.

<Method for Manufacturing Article with Microrelief Structure on Surface>

Next, a description will be given of a method for manufacturing an article with a microrelief structure of the invention on a surface. In the present embodiment, an example of manufacturing a film 80 as an article with a microrelief structure on a surface using a film manufacturing apparatus 60 illustrated in FIG. 9 will be described as the manufacturing method of the invention. That is, for example, an article obtained by the method for manufacturing an article with a microrelief structure of the invention on a surface is a film-shaped article.

The film manufacturing apparatus 60 in the example illustrated in FIG. 9 broadly includes a roll-shaped mold (main mold body) 61, which is manufactured by the above-described method of manufacturing a mold, having a multi-microrelief structure, an average period of which is 400 nm or less, on a surface, a resin supply means 62 for supplying an active energy ray curable resin composition (hereinafter may be abbreviated to “resin composition”) to between the roll-shaped mold 61 and a film-shaped support 81 continuously conveyed to the roll-shaped mold 61, a nip roller 64 that nips the film-shaped support 81 and the resin composition supplied on the film-shaped support 81, an active energy ray irradiation device 65 disposed below the roll-shaped mold 61, and a peeling roller 66 that peels off the film 80, which is obtained when a curable resin layer to which a surface structure of the roll-shaped mold 61 is transferred is formed on a surface of the film-shaped support 81, from the roll-shaped mold 61.

In addition, when the film manufacturing apparatus 60 is used, it is possible to manufacture the film 80 having a plurality of protrusions, in which an average interval of adjacent protrusions is 400 nm or less, on a surface by transferring the surface structure of the roll-shaped mold 61.

The resin supply means 62 supplies the resin composition to between the film-shaped support 81 and the roll-shaped mold 61, and includes a tank 62a that stores the resin composition, a dispenser 62b that discharges the resin composition, a pipe 62c that connects the tank 62a to the dispenser 62b, and a pump 62d that supplies air into the tank 62a to send out the resin composition from the tank 62a. In addition, the pump 62d includes a temperature control means (not illustrated) capable of controlling air supplied into the tank 62a at a predetermined temperature. Herein, the temperature control means may be included inside the tank 62a such that the resin composition stored inside the tank 62a can be maintained at a predetermined temperature.

In the invention, the dispenser 62b is held to be movable in parallel with a central axis direction of the roll-shaped mold 61. In addition, when the amount of air supplied into the tank 62a from the pump 62d is adjusted, it is possible to adjust the amount of the resin composition supplied from the dispenser 62b.

The roll-shaped mold 61 has a microrelief structure on a surface, and forms a shape corresponding to the above-described relief structure in a curable resin layer. For example, a material made of metal such as aluminum or titanium, a material made of a synthetic resin such as silicone resin, polyurethane resin, epoxy resin, ABS resin, fluoride resin, or polymethylpentene resin, a material manufactured using a Ni electroforming method, etc. is used for at least an external surface of the roll-shaped mold 61. The roll-shaped mold 61 preferably uses a material made of metal in terms of heat resistance, strength, etc, and more preferably uses a material made of aluminum in that the microrelief structure is formed on the surface. In addition, a mold obtained by winding and fixing a film-shaped member having a microrelief structure around an outer circumferential surface of a cylindrical roll may be used as the roll-shaped mold.

A flow passage capable of circulating a temperature control medium is formed inside the roll-shaped mold 61, and a temperature control medium having a desired temperature may be supplied to the roll-shaped mold 61. When the temperature control medium is circulated through the flow passage of the temperature control medium formed inside the roll-shaped mold 61, a temperature of the outer circumferential surface of the roll-shaped mold 61 may be adjusted within a desired range.

The nip roller 64 for equalizing a thickness of the supplied resin composition is installed on an outside of the film-shaped support 62 (on an opposite side from the roll-shaped mold 61 side). For example, a metal roller, a rubber roller, etc. is used as the nip roller 64. In addition, in order to equalize the thickness of the resin composition, the nip roller 64 is preferably processed at high accuracy with regard to roundness, surface roughness, etc. When the rubber roller is used, the rubber roller preferably has high rubber hardness greater than or equal to 40 degrees.

Referring to the nip roller 64, the thickness of the resin composition needs to be accurately adjusted, and a pressure application operation is performed to press the nip roller 64 in a direction of the roll-shaped mold 61 using a pressure adjusting mechanism (not illustrated). For example, a hydraulic cylinder, a pneumatic cylinder, various screw mechanism, etc. may be used as the pressure adjusting mechanism. However, the pneumatic cylinder is preferably used in terms of simplicity of the mechanism, etc.

A flow passage capable of circulating a temperature control medium inside the roll-shaped mold 61 is formed inside the roll-shaped mold 61, and a temperature control medium having a desired temperature may be supplied to the roll-shaped mold 61. When the temperature control medium is circulated through the flow passage of the temperature control medium formed inside the roll-shaped mold 61, the temperature of the outer circumferential surface of the roll-shaped mold 61 may be adjusted within a desired range.

Examples of the active energy ray irradiation device 65 include a high pressure mercury lamp, a metal halide lamp, etc.

When the film 80 is manufactured using the film manufacturing apparatus 60 illustrated in FIG. 9, for example, the film 80 may be manufactured in the following procedure.

First, the resin composition is supplied from the resin supply means 62 to between the roll-shaped mold 61 and the film-shaped support 81 continuously conveyed to the roll-shaped mold 61. In this instance, the supplied resin composition forms a resin reservoir 63 between the roll-shaped mold 61 and the film-shaped support 81.

Herein, a width of the resin reservoir 63 may change due to a change in viscosity, etc. resulting from a temperature change of the resin composition. Thus, it is preferable to suppress the temperature change of the resin composition to the minimum. In the invention, for example, it is preferable that a hot-water jacket, a heat/cold reserving material, etc. be installed around the tank 62a, the dispenser 62b, and the pipe 62c, thereby suppressing the temperature change of the resin composition. Further, air supplied from the pump 62d is a main cause of the temperature change of the resin composition. Thus, it is more preferable to adjust a temperature of air supplied to the tank 62a using the temperature control means of the pump 62d. In this way, it is possible to suppress the temperature change of the resin composition due to a variation in temperature of air supplied into the tank 62a.

In this way, it is possible to suppress a change in width or position of the resin reservoir 63 by inhibiting a resin temperature from changing during a process of manufacturing the film 80.

The temperature of the resin composition held inside the tank 62a is preferably in a range of 20 to 80° C., and more preferably in a range of 30 to 60° C. In addition, the temperature of air supplied into the tank 62a is preferably in a range of 20 to 80° C., and more preferably in a range of 30 to 60° C. When the temperature of the resin composition is less than or equal to 20° C., viscosity of the resin composition increases, and there is difficulty in adjusting the resin reservoir 63 to a predetermined width in some cases. On the other hand, when the temperature of the resin composition is greater than or equal to 80° C., the resin composition volatilizes, or viscosity of the resin composition excessively decreases. Thus, there is difficulty in adjusting the resin reservoir 63 to the predetermined width in some cases.

It is preferable that a difference between the temperature of the resin composition held inside the tank 62a and the temperature of air supplied into the tank 62a be within ±5° C., and it is more preferable that the temperatures are the same.

In addition, the temperature of the resin composition supplied from the resin supply means 62 changes due to an influence of the roll-shaped mold 61 and the nip roller 64 in the resin reservoir 63, and the width or the position of the resin reservoir 63 changes in some cases. In the invention, a passage for supplying the temperature control medium is formed inside the roll-shaped mold 61 and the nip roller 64. In this way, surface temperatures of the roll-shaped mold 61 and the nip roller 64 may be controlled. In this way, it is possible to control the temperature change of the resin composition due to the influence of the roll-shaped mold 61 and the nip roller 64, and suppress the change of the width or the position of the resin reservoir 63. In this case, the temperature of the outer circumferential surface of the roll-shaped mold 61 is preferably in a range of 20° C. to 80° C., and more preferably in a range of 30° C. to 60° C. When the temperature of the outer circumferential surface of the roll-shaped mold 61 is less than or equal to 20° C., viscosity of the resin composition increases, and there is difficulty in adjusting the resin reservoir 63 to a predetermined width in some cases. In addition, when the temperature of the outer circumferential surface of the roll-shaped mold 61 is greater than or equal to 80° C., the resin composition volatilizes, or viscosity of the resin composition excessively decreases. Thus, there is difficulty in adjusting the resin reservoir 63 to the predetermined width in some cases.

In addition, a temperature of an outer circumferential surface of the nip roller 64 is preferably in a range of 20° C. to 80° C., and more preferably in a range of 30° C. to 60° C. When the temperature of the outer circumferential surface of the nip roller is less than or equal to 20° C., viscosity of the resin composition increases, and there is difficulty in adjusting the resin reservoir 63 to a predetermined width in some cases. In addition, when the temperature of the outer circumferential surface of the nip roller is greater than or equal to 80° C., the resin composition volatilizes, or viscosity of the resin composition excessively decreases. Thus, there is difficulty in adjusting the resin reservoir 63 to the predetermined width in some cases.

Further, it is preferable that a difference between the temperature of the outer circumferential surface of the roll-shaped mold 61 and the temperature of the outer circumferential surface of the nip roller 64 be within ±3° C., and it is more preferable that the temperatures are the same. In addition, it is preferable that the temperatures of the roll-shaped mold 61 and the nip roller 64 be the same as the temperature of the resin composition supplied from the resin supply means 62.

A temperature of the roll-shaped mold 61 is prone to gradually rise due to heat of polymerization of the resin composition or irradiation heat from the active energy ray irradiation device 65. Therefore, in order to control the temperature of the roll-shaped mold 61, it is preferable that a temperature control medium for cooling be supplied into the roll-shaped mold 61, thereby cooling the roll-shaped mold 61. Meanwhile, since a temperature of the nip roller 64 becomes equal to a temperature of a manufacturing atmosphere in many cases, a surface temperature of the nip roller 64 becomes lower than the temperature of the resin composition in many cases. Therefore, in order to control the temperature of the nip roller 64, it is preferable that a temperature control medium for heating be supplied into the nip roller 64, thereby heating the nip roller 64.

Subsequently, the film-shaped support 81 and the resin composition are nipped between the roll-shaped mold 61 and the nip roller 64, and a curable resin composition is uniformly diffused between the film-shaped support 81 and the roll-shaped mold 61. At the same time, when a microrelief structure is formed on a surface of the roll-shaped mold 61, a depression of the microrelief structure is filled with the curable resin composition. In this instance, the curable resin composition is attached to a portion other than the depression on the surface of the roll-shaped mold 61.

In addition, for example, the curable resin composition is irradiated with an active energy ray such as an ultraviolet ray penetrating the film-shaped support 81 from the active energy ray irradiation device 61 installed below the roll-shaped mold 61 to harden the curable resin composition, thereby forming a curable resin layer 68 to which the surface structure of the roll-shaped mold 61 is transferred.

Subsequently, the film 80 on which the curable resin layer 68 is formed is peeled off from the roll-shaped mold 61 by the peeling roller 66.

The method for manufacturing the article with the microrelief structure on the surface of the invention is not restricted to the above-described method. For example, the curable resin layer 68 may be formed by supplying the resin composition onto the film-shaped support 62 or the roll-shaped mold 61, and forming the resin reservoir 63 between the roll-shaped mold 61 and the film-shaped support 62.

[Resin Composition]

The resin composition used in the method for manufacturing the article with the microrelief structure on the surface of the invention includes at least a polymerizable compound and a polymerization initiator.

(Polymerizable Compound)

Examples of the polymerizable compound contained in the resin composition include monomers, oligomers, and reactive polymers having a radical polymerizable bond and/or a cationic polymerizable bond in the molecule.

Examples of the monomers having a radical polymerizable bond include a monofunctional monomer and a polyfunctional monomer. Examples of the monofunctional monomer include (meth)acrylate derivatives such as methyl (meth)acrylate, ethyl (meth)acrylate, propyl (meth)acrylate, n-butyl (meth)acrylate, i-butyl (meth)acrylate, s-butyl (meth)acrylate, t-butyl (meth)acrylate, 2-ethylhexyl (meth)acrylate, lauryl (meth)acrylate, alkyl (meth)acrylate, tridecyl (meth)acrylate, stearyl (meth)acrylate, cyclohexyl (meth)acrylate, benzyl (meth)acrylate, phenoxyethyl (meth)acrylate, isobornyl (meth)acrylate, glycidyl (meth)acrylate, tetrahydrofurfuryl (meth)acrylate, allyl (meth)acrylate, 2-hydroxyethyl (meth)acrylate, hydroxypropyl (meth)acrylate, 2-methoxyethyl (meth)acrylate, and 2-ethoxyethyl (meth)acrylate; (meth)acrylic acid and (meth)acrylonitrile; styrene derivatives such as styrene and α-methyl styrene; and (meth)acrylamide derivatives such as (meth)acrylamide, N-dimethyl (meth)acrylamide, N-diethyl (meth)acrylamide, and dimethylaminopropyl (meth)acrylamide. These may be used singly or in combination of two or more kinds thereof.

Examples of the polyfunctional monomer include bifunctional monomers such as ethylene glycol di(meth)acrylate, tripropylene glycol di(meth)acrylate, ethylene oxide isocyanurate-modified di(meth)acrylate, triethylene glycol di(meth)acrylate, diethylene glycol di(meth)acrylate, neopentyl glycol di(meth)acrylate, 1,6-hexanediol di(meth)acrylate, 1,5-pentanediol di(meth)acrylate, 1,3-butylene glycol di(meth)acrylate, polybutylene glycol di(meth)acrylate, 2,2-bis(4-(meth)acryloxypolyethoxyphenyl)propane, 2,2-bis(4-(meth)acryloxyethoxyphenyl)propane, 2,2-bis(4-(3-(meth)acryloxy-2-hydroxypropoxy)phenyl)propane, 1,2-bis(3-(meth)acryloxy-2-hydroxypropoxy)ethane, 1,4-bis(3-(meth)acryloxy-2-hydroxypropoxy)butane, dimethyloltricyclodecane di(meth)acrylate, di(meth)acrylates of ethylene oxide adducts of bisphenol A, di(meth)acrylates of propylene oxide adducts of bisphenol A, neopentyl glycol hydroxypivalate di(meth)acrylate, divinylbenzene, and methylene bisacrylamide; trifunctional monomers such as pentaerythritol tri(meth)acrylate, trimethylolpropane tri(meth)acrylate, ethylene oxide-modified tri(meth)acrylates of trimethylolpropane, propylene oxide-modified triacrylates of trimethylolpropane, ethylene oxide-modified triacrylates of trimethylolpropane, and ethylene oxide isocyanurate-modified tri(meth)acrylate; tetra- or higher functional monomers such as condensation reaction mixtures of succinic acid/trimethylol ethane/acrylic acid, dipentaerythritol hexa(meth)acrylate, dipentaerythritol penta(meth)acrylate, ditrimethylol propane tetraacrylate, and tetramethylol methane tetra(meth)acrylate; bi- or higher functional urethane acrylates, and bi- or higher functional polyester acrylates. These may be used singly or in combination of two or more kinds thereof.

Examples of the monomers having a cationic polymerizable bond include monomers having an epoxy group, an oxetanyl group, an oxazolyl group, or a vinyl oxy group, and the monomers having an epoxy group are particularly preferable.

Examples of the oligomers or the reactive polymers include unsaturated polyesters such as condensation products of unsaturated dicarboxylic acid and polyhydric alcohol; polyester (meth)acrylate, polyether (meth)acrylate, polyol (meth)acrylate, epoxy (meth)acrylate, urethane (meth)acrylate, cationic polymerizable epoxy compounds, and homopolymers or copolymers of the above monomers having a radical polymerizable bond on a side chain thereof.

(Polymerization Initiator)

In the case of using a photocuring reaction, examples of the photopolymerization initiators include carbonyl compounds such as benzoin, benzoin methyl ether, benzoin ethyl ether, benzoin isopropyl ether, benzoin isobutyl ether, benzyl, benzophenone, p-methoxybenzophenone, 2,2-diethoxy acetophenone, α,α-dimethoxy-α-phenyl acetophenone, methylphenyl glyoxylate, ethylphenyl glyoxylate, 4,4′-bis(dimethylamino) benzophenone, and 2-hydroxy-2-methyl-1-phenylpropan-1-one; sulfur compounds such as tetramethyl thiuram monosulfide and tetramethyl thiuram disulfide; 2,4,6-trimethyl benzoyl diphenyl phosphine oxide, and benzoyl diethoxy phosphine oxide. These may be used singly or in combination of two or more kinds thereof.

In the case of using an electron beam curing reaction, examples of the polymerization initiators include thioxanthone such as benzophenone, 4,4-bis(diethylamino) benzophenone, 2,4,6-trimethyl benzophenone, methyl ortho-benzoylbenzoate, 4-phenylbenzophenone, t-butylanthraquinone, 2-ethyl anthraquinone, 2,4-diethyl thioxanthone, isopropylthioxanthone, and 2,4-dichlorothioxanthone; acetophenone such as diethoxyacetophenone, 2-hydroxy-2-methyl-1-phenylpropan-1-one, benzyldimethylketal, 1-hydroxycyclohexyl-phenyl ketone, 2-methyl-2-morpholino (4-thiomethylphenyl)propan-1-one, and 2-benzyl-2-dimethylamino-1-(4-morpholinophenyl)-butanone; benzoin ethers such as benzoin methyl ether, benzoin ethyl ether, benzoin isopropyl ether, and benzoin isobutyl ether; acyl phosphine oxides such as 2,4,6-trimethyl benzoyl diphenyl phosphine oxide, bis(2,6-dimethoxyphenyl)-2,4,4-trimethyl pentyl phosphine oxide, and bis(2,4,6-trimethylbenzoyl)-phenyl phosphine oxide; methyl benzoyl formate, 1,7-bisacridinylheptane, and 9-phenylacridine. These may be used singly or in combination of two or more kinds thereof.

Incidentally, in the case of using a thermal curing reaction instead of the photocuring reaction using the active energy ray described above, for example, a configuration can be employed in which the active energy ray irradiation device 65 is replaced with a heat ray irradiation device or the like and a thermal polymerization initiator, which will be exemplified below, is contained as the resin composition. Further, a configuration may be employed in which, without use of the active energy ray irradiation device 65 or the like, for example, a heater or the like, which can control the surface temperature of the roll-shaped mold 61, is provided in the roll-shaped mold 61, and a thermal polymerization initiator, which will be exemplified below, is contained as the resin composition.

In the case of using a thermal curing reaction, examples of the thermal polymerization initiator include organic peroxides such as methyl ethyl ketone peroxide, benzoyl peroxide, dicumyl peroxide, t-butyl hydroperoxide, cumene hydroperoxide, t-butyl peroxy octoate, t-butyl peroxybenzoate, and lauroyl peroxide; azo compounds such as azobisisobutyronitrile; and a redox polymerization initiator such as a combination of amine such as N,N-dimethyl aniline or N,N-dimethyl-p-toluidine with the above organic peroxides.

The amount of the polymerization initiator is preferably 0.1 to 10 parts by mass with respect to 100 parts by mass of the polymerizable compound. When the amount of the polymerizable compound is less than 0.1 part by mass, polymerization is tend to be difficult to proceed. When the amount of the polymerizable compound is more than 10 parts by mass, the curable resin layer may be colored or the mechanical strength may be lowered.

(Other Components)

The resin composition may contain, as necessary, a non-reactive polymer, an active energy ray sol-gel reaction composition, an antistatic agent, an additive, such as a fluorine compound, used for improving antifouling property, fine particles, and a small amount of a solvent.

Examples of the non-reactive polymer include acrylic resins, styrene resins, polyurethane, cellulose resins, polyvinyl butyral, polyesters, and thermoplastic elastomers. Examples of the active energy ray sol-gel reaction composition include alkoxysilane compounds and alkyl silicate compounds.

Examples of the alkoxysilane compounds include tetramethoxysilane, tetra-i-propoxysilane, tetra-n-propoxysilane, tetra-n-butoxysilane, tetra-sec-butoxysilane, tetra-t-butoxysilane, methyltriethoxysilane, methyl tripropoxy silane, methyl tributoxy silane, dimethyl dimethoxy silane, dimethyl diethoxy silane, trimethyl ethoxy silane, trimethyl methoxy silane, trimethyl propoxy silane, and trimethyl butoxy silane. Examples of the alkyl silicate compounds include methyl silicate, ethyl silicate, isopropyl silicate, n-propyl silicate, n-butyl silicate, n-pentyl silicate, and acetyl silicate.

(Internal Mold Release Agent)

The resin composition preferably contains an internal mold release agent. In this way, mold release characteristics of the roll-shaped mold 61 and the curable resin layer 68 are improved, and thus the film 80 is easily peeled off from the roll-shaped mold 61.

Examples of the internal mold release agent include fluorine-containing compounds, silicone compounds, phosphate ester compounds, compounds having a long-chain alkyl group, compounds having a polyoxyalkylene group, and solid wax (polyethylene wax, amide wax, polytetrafluoroethylene powders, or the like). Among the above compositions, from the viewpoint of achieving the suitable mold release characteristic between the curable resin layer of the resin composition and the mold (the roll-shaped mold), a (poly)oxyalkylene alkyl phosphate ester compound is preferably contained as the internal mold release agent.

From the viewpoint of the mold release characteristic, a compound represented by the following Formula (1) is preferably used as the (poly)oxyalkylene alkyl phosphate ester compound.

(HO)₃-n(O═)P[—O—(CH₂CH₂O)m-R1]ₙ (1)

Here, in the above Formula (1), R1 is an alkyl group, m is an integer of 1 to 20, and n is an integer of 1 to 3.

R1 in the above Formula (1) is preferably an alkyl group having 1 to 20 carbon atoms and more preferably an alkyl group having 3 to 18 carbon atoms. Further, m is more preferably an integer of 1 to 10. The (poly)oxyalkylene alkyl phosphate ester compound may be any of monoesters (n=1), diesters (n=2), and triesters (n=3). Further, in the case of diesters or triesters, a plurality of (poly)oxyalkylene alkyl groups in one molecule may be different from one another.

Commercially available products can be used as the (poly)oxyalkylene alkyl phosphate ester compound. Examples of the commercially available products include “JP-506H” manufactured by Johoku Chemical Co., Ltd.; “MOLD WIZ INT-1856” (registered trademark) manufactured by Axel Plastics Research Laboratories, Inc.; and “TDP-10”, “TDP-8”, “TDP-6”, “TDP-2”, “DDP-10”, “DDP-8”, “DDP-6”, “DDP-4”, “DP-2”, “TLP-4”, “TCP-5”, and “DLP-10” manufactured by Nikko Chemicals Co., Ltd.

Further, these (poly)oxyalkylene alkyl phosphate ester compounds may be used singly or in combination of two or more kinds thereof.

The amount of the (poly)oxyalkylene alkyl phosphate ester compound is preferably 0.01 to 1 part by mass, more preferably 0.05 to 0.5 part by mass, and still more preferably 0.05 to 0.1 part by mass with respect to 100 parts by mass of the polymerizable compound. When the amount of the (poly)oxyalkylene alkyl phosphate ester compound in the internal mold release agent is 1 part by mass or less, a decrease in adhesion between the film-shaped support 81 and the curable resin layer 68 is suppressed, and as a result, the resin residue on the roll-shaped mold 61 is suppressed. In addition, when the amount of the (poly)oxyalkylene alkyl phosphate ester compound in the internal mold release agent is 0.01 part by mass or more, the mold release characteristic of the curable resin layer 68 from the roll-shaped mold 61 becomes sufficient and occurrence of the resin residue on the roll-shaped mold 61 is suppressed.

<Film-Shaped Support>

In the invention, as for the film-shaped support 81, those not significantly inhibiting irradiation of active energy ray are preferred since the irradiation of active energy ray is performed through the film-shaped support 81. Examples of the material of the film-shaped support 81 include a polycarbonate resin, a polystyrene resin, a polyester resin (polyethylene terephthalate, polybutylene terephthalate, or the like), an acrylic resin, a cellulose resin (triacetyl cellulose, or the like), polyolefin, and glass.

### EXAMPLES

Hereinafter, the invention will be described in detail using examples. However, the invention is not restricted thereto.

(Average Interval and Depth of Pore)

A portion of anodized alumina was cut, platinum was deposited on a section for one minute, and the section was observed on condition of an acceleration voltage of 3.00 kV using a field emission scanning electron microscope (manufactured by JEOL Ltd., JSM-7400F) to measure an interval of pores and a depth of a pore. Each of the interval and the depth was measured with respect to fifty samples, and averages were obtained.

(Irregularity in Film Thickness of Release Layer)

An image of an outer circumferential surface of a roll-shaped mold was obtained using an inspection apparatus described in JP 5049405 B1. A state of a mold release agent layer was visually checked from the obtained image, and irregularity in film thickness of the mold release agent layer was evaluated using the following criteria.

A: Irregularity in film thickness of the mold release agent layer was rarely generated across the whole outer circumferential surface of the roll-shaped mold.

B: A difference in film thickness of the mold release agent layer was generated between a first end portion of a main mold body and a region other than the first end portion.

C: Irregularity in film thickness of the mold release agent layer was partially generated on the outer circumferential surface of the roll-shaped mold.

D: Irregularity in film thickness of the mold release agent layer was generated across the whole outer circumferential surface of the roll-shaped mold.

(Manufacturing of Main Mold Body)

A hollow roll-shaped aluminum base material including a body portion having a length of 320 mm, an external diameter of 200 mm, and an internal diameter of 155 mm, and a small-diameter portion having a length of 20 mm, an external diameter of 190 mm, and an internal diameter of 155 mm installed in a protruding manner from both ends of the body portion was prepared as an aluminum base material (purity of 99.99%).

The aluminum base material was subjected to electrolytic polishing in a perchloric acid/ethanol mixed solution (a volume ratio of 1/4).

Process (a): Anodic oxidation was performed on the aluminum base material subjected to electrolytic polishing for six hours on condition of a direct current of 40 V and a temperature of 16° C. in an oxalic acid aqueous solution of 0.3 M.

Process (b): The aluminum base material on which an oxide film has been formed was immersed in a mixed aqueous solution of phosphoric acid of 6% by mass/chromic acid of 1.8% by mass for three hours to remove the oxide film.

Process (c): Anodic oxidation was performed on the aluminum base material from which the oxide film has been removed for 30 seconds on condition of a direct current of 40 V and a temperature of 16° C. in an oxalic acid aqueous solution of 0.3 M.

Process (d): The aluminum base material on which the oxide film has been formed was immersed in a phosphoric acid aqueous solution of 5% by mass of 32° C. for eight minutes to perform a pore diameter enlargement treatment.

Process (e): Anodic oxidation was performed on the aluminum base material subjected to the pore diameter enlargement treatment for 30 seconds on condition of a direct current of 40 V and a temperature of 16° C. in an oxalic acid aqueous solution of 0.3 M.

Process (f): Process (d) and process (e) were repeated four times in total, and process (d) was finally performed once, thereby obtaining a main mold body in which anodized alumina having a substantially conical pore (average interval: 100 nm, depth: 240 nm) was formed on an outer circumferential surface.

After the phosphoric acid aqueous solution attached to the surface of the obtained main mold body was lightly washed away using a shower, the main mold body was immersed in flowing water for ten minutes and cleaned.

After the main mold body was cleaned, moisture attached to the surface was blown away using gas to dry the main mold body.

### Example 1

The manufacturing apparatus 1 illustrated in FIG. 2 to FIG. 4 was prepared. However, two mold release agent discharging nozzles 30 and two gas discharging nozzles 40 were prepared, a first gas discharging nozzle, a second gas discharging nozzle, a first mold release agent discharging nozzle, and a second mold release agent discharging nozzle were arranged side by side in order from the first end portion 10a side toward the second end portion 10b side of the main mold body 10, and the nozzle fixture 52 was fixed.

The manufacturing method in the first embodiment described above was performed under a condition below to obtain a roll-shaped mold. Results are shown in Table 1.

(Condition)
Direction of central axis of main mold body: horizontal direction)(0°
Distance between main mold body and mold release agent discharging nozzle: 75 mm
Distance between main mold body and gas discharging nozzle: 8 mm
Distance between first mold release agent discharging nozzle and second mold release agent discharging nozzle: 45 mm
Distance between first mold release agent discharging nozzle and second gas discharging nozzle: 60 mm
Distance between first gas discharging nozzle and second gas discharging nozzle: 70 mm
Moving speed of mold release agent discharging nozzle: 1 mm/sec
Moving speed of gas discharging nozzle: 1 mm/sec
Rotations per minute (RPM) of main mold body: 20 rpm
Rotation direction of main mold body: direction opposite to gas discharge direction of gas discharging nozzle
Discharge width of gas: 90 mm
Pressure of gas: 0.4 MPa
Angle θ formed between discharge direction of gas and central axis of main mold body: 45°
Type of gas: air
Discharge flow rate of mold release agent solution: 600 mL/min
Spread width w of mold release agent solution: shown in Table 1
Initial retention time: shown in Table 1
Wetted time: 90 seconds
Mold release agent solution: Phosphate ester solution of 0.1% by mass

### Examples 2 to 6

A roll-shaped mold was obtained similarly to Example 1 except that an initial retention time was changed. Results are shown in Table 1.

TABLE 1

| | Spread width w of | Initial | Irregularity in film |
|---|---|---|---|
| | mold release agent | retention time | thickness of mold |
| | solution [mm] | [sec] | release agent layer |
| Example 1 | 40 | 0 | B |
| Example 2 | 90 | 40 | B |
| Example 3 | 90 | 60 | A |
| Example 4 | 90 | 90 | A |
| Example 5 | 90 | 120 | A |
| Example 6 | 90 | 180 | A |

Irregularity in film thickness of the mold release agent layer could be nearly suppressed by manufacturing the roll-shaped mold using the manufacturing method in the first embodiment.

In addition, results of Examples 3 to 6 show that an initial retention time needs to be set in order to suppress irregularity in film thickness of the mold release agent layer on an outer circumferential surface of the first end portion of the main mold body, and it is preferable that the initial retention time be set to 60 minutes or more with respect to a spread width of 90 mm of the mold release agent solution.

In Examples 1 and 2, it is presumed that a difference in film thickness of the mold release agent layer was generated between the first end portion side and the second end portion side since an initial retention time was short.

### Example 7

The manufacturing apparatus 2 illustrated in FIG. 6 to FIG. 8 was prepared.

The manufacturing method in the second embodiment described above was performed under a condition below to obtain a roll-shaped mold. Results are shown in Table 2.

(Condition)
Direction of central axis of main mold body: horizontal direction)(0°)
Distance between main mold body and mold release agent discharging nozzle: 30 mm
Distance between main mold body and gas discharging nozzle: 8 mm
Moving speed of gas discharging nozzle: 5 mm/sec
Rotations per minute (RPM) of main mold body: 20 rpm
Rotation direction of main mold body: direction opposite to gas discharge direction of gas discharging nozzle
Discharge width of gas: 90 mm
Pressure of gas: 0.4 MPa
Angle θ formed between discharge direction of gas and central axis of main mold body: 45°
Type of gas: air
Wetted time: 60 seconds
Mold release agent solution: Phosphate ester solution of 0.1% by mass

TABLE 2

| | | Irregularity in film thickness of mold |
|---|---|---|
| | Pressure of gas [MPa] | release agent layer |
| Example 7 | 0.4 | B |

Irregularity in film thickness of the mold release agent layer could be nearly suppressed by manufacturing the roll-shaped mold using the manufacturing method in the second embodiment.

### INDUSTRIAL APPLICABILITY

A roll-shaped mold obtained by a manufacturing method of the invention is useful as a roll-shaped mold, which is used for a nanoimprint method, having a microrelief structure on a surface, an embossing roll used for an embossing formation, a roll-shaped stamper used to form a bit of a recording medium, etc.

### EXPLANATIONS OF LETTERS OR NUMERALS

1: manufacturing apparatus
2: manufacturing apparatus
10: main mold body
10a: first end portion
10b: second end portion
10c: circumference
12: aluminum base material
14: pore
16: oxide film
18: pore originating point
20: rotating mechanism (rotating means)
21: main shaft-side holder
22: tail-side holder
23: main shaft-side shaft
24: tail-side shaft
25: shaft support
26: rotation driving unit
27: belt
30: mold release agent discharging nozzle (mold release agent discharging means)
32: nozzle fixture
40: gas discharging nozzle (gas discharging means)
50: moving mechanism (moving means)
52: nozzle fixture
54: linear guide
60: film manufacturing apparatus
61: roll-shaped mold
62: resin supply means
63: resin reservoir
64: nip roller
65: active energy ray irradiation device
66: peeling roller
68: curable resin layer
80: film
81: film-shaped support
w: spread width of mold release agent solution
θ: angle

1. A method of manufacturing a mold in which a mold release agent layer is formed on a main mold body, the method comprising:
supplying a mold release agent solution toward the main mold body from a mold release agent discharging means disposed to be separated from the main mold body to attach the mold release agent solution to the main mold body; and
discharging gas toward the mold release agent solution attached to the main mold body from a gas discharging means disposed to be separated from the main mold body to dry the mold release agent solution, thereby forming the mold release agent layer.

2. The method according to claim 1, wherein the main mold body is a roll-shaped main mold body having an external shape corresponding to a cylindrical shape, and the mold release agent solution is supplied to an outer circumferential surface of the roll-shaped main mold body while the roll-shaped main mold body is rotated using a central axis of the roll-shaped main mold body as a rotation axis.

3. The method according to claim 2, wherein the roll-shaped main mold body is held and rotated such that the central axis is in a horizontal direction.

4. The method according to claim 2, wherein the mold release agent solution is supplied toward the outer circumferential surface of the main mold body from the mold release agent discharging means while the main mold body and the mold release agent discharging means are relatively moved from a first end portion to a second end portion of the main mold body in parallel with the central axis of the main mold body.

5. The method according to claim 4, wherein gas is discharged toward the mold release agent solution attached to the outer circumferential surface of the main mold body from the gas discharging means while the main mold body and the gas discharging means are relatively moved such that the gas discharging means disposed at a rear of the mold release agent discharging means in a movement direction of the mold release agent discharging means follows the mold release agent discharging means.

6. The method according to claim 3, wherein the mold release agent solution is attached to the outer circumferential surface of the main mold body by supplying the mold release agent solution toward a lower half on the outer circumferential surface of the main mold body from the mold release agent discharging means.

7. The method according to claim 2, wherein the mold release agent solution is supplied toward the outer circumferential surface of the main mold body from a plurality of mold release agent discharging means arranged side by side at equal intervals along a longitudinal direction of the main mold body.

8. The method according to claim 7, wherein gas is discharged toward the mold release agent solution attached to the outer circumferential surface of the main mold body from the gas discharging means while the mold release agent solution is successively attached to the outer circumferential surface of the main mold body by discharging the mold release agent solution toward the outer circumferential surface of the main mold body in order from the mold release agent discharging means on a side of the first end portion of the main mold body among the plurality of mold release agent discharging means arranged side by side at equal intervals along the longitudinal direction of the main mold body.

9. The method according to claim 2, wherein gas is discharged toward the mold release agent solution attached to the outer circumferential surface of the main mold body from the gas discharging means such that a discharge direction of the gas from the gas discharging means is a direction opposite to a rotation direction of the main mold body.

10. The method according to claim 2, wherein gas is discharged toward the mold release agent solution attached to the outer circumferential surface of the main mold body and positioned in an upper half on the outer circumferential surface of the main mold body from the gas discharging means positioned higher than the mold release agent discharging means.

11. The method according to claim 1, wherein the main mold body corresponds to a structure having a plurality of minute protrusions and depressions, in which an average interval of respective adjacent protrusions or depressions is set to 400 nm or less, on the outer circumferential surface of the main mold body.

12. An apparatus for manufacturing a roll-shaped mold in which a mold release agent layer is formed on an outer circumferential surface of a roll-shaped main mold body, the apparatus comprising:
a rotating means for rotating the main mold body using a central axis of the main mold body as a rotation axis;
a mold release agent discharging means disposed to be separated from the main mold body to discharge a mold release agent solution toward the outer circumferential surface of the main mold body, thereby attaching the mold release agent solution to the outer circumferential surface of the main mold body; and
a gas discharging means disposed to be separated from the main mold body to discharge gas toward the mold release agent solution attached to the outer circumferential surface of the main mold body, thereby drying the mold release agent solution to form the mold release agent layer.

13. The apparatus according to claim 12, wherein the rotating means holds the roll-shaped main mold body such that the central axis is in a horizontal direction, and rotates the roll-shaped main mold body.

14. The apparatus according to claim 12, wherein the mold release agent discharging means is relatively movable with respect to the main mold body in parallel with the central axis of the main mold body.

15. The apparatus according to claim 14, wherein the gas discharging means is disposed at a rear of the mold release agent discharging means in a movement direction of the mold release agent discharging means, and is relatively movable with respect to the main mold body by following the mold release agent discharging means.

16. The apparatus according to claim 12, wherein the main mold body corresponds to a structure having a plurality of minute protrusions and depressions, in which an average interval of respective adjacent protrusions or depressions is set to 400 nm or less, on the outer circumferential surface of the main mold body.

17. A method for manufacturing an article with a microrelief structure on a surface, the method comprising:
forming a structuring having a plurality of protrusions and depressions, an average period of which is 400 nm or less, on a surface of a roll-shaped main mold body;
attaching a mold release agent solution to an outer circumferential surface of the main mold body by supplying the mold release agent solution toward the outer circumferential surface of the main mold body from a mold release agent discharging means disposed to be separated from the main mold body while rotating the main mold body using a central axis of the main mold body as a rotation axis; and
manufacturing an article with a plurality of protrusions, in which an average interval of adjacent protrusions is 400 nm or less, on a surface by transferring a structure of the surface of the roll-shaped main mold body on which a mold release agent layer is formed to a curable resin layer using a mold manufactured by discharging gas toward the mold release agent solution coming into contact with the outer circumferential surface of the main mold body from a gas discharging means disposed to be separated from the main mold body to dry the mold release agent solution to form the mold release agent layer.

18. The method according to claim 17, wherein the roll-shaped main mold body is held and rotated such that the central axis is in a horizontal direction.

19. The method according to claim 18, wherein the roll-shaped main mold body is obtained by supplying the mold release agent solution to the outer circumferential surface of the main mold body from the mold release agent discharging means while relatively moving the main mold body and the mold release agent discharging means such that the mold release agent discharging means faces from a first end portion to a second end portion of the main mold body in parallel with the central axis of the main mold body.

20. The method according to claim 19, wherein the roll-shaped main mold body is obtained by discharging gas to the mold release agent solution coming into contact with the outer circumferential surface of the main mold body from the gas discharging means while relatively moving the main mold body and the gas discharging means such that the gas discharging means disposed at a rear of the mold release agent discharging means in a movement direction of the mold release agent discharging means follows the mold release agent discharging means.
